(19) United States
(12) Patent Application Publication
(10) Pub. No.: US 2022/0326632 A1
(43) Pub. Date: Oct. 13, 2022

(54) TONER, DEVELOPING AGENT, TONER HOUSING UNIT, IMAGE FORMING APPARATUS, AND A METHOD OF FORMING IMAGES

(71) Applicants: Keiji MAKABE, Shizuoka (JP); Akira Tanaka, Shizuoka (JP); Hidekazu Kakinuma, Shizuoka (JP); Tsukiko Takahashi, Shizuoka (JP)

(72) Inventors: Keiji MAKABE, Shizuoka (JP); Akira Tanaka, Shizuoka (JP); Hidekazu Kakinuma, Shizuoka (JP); Tsukiko Takahashi, Shizuoka (JP)

(73) Assignee: Ricoh Company, Ltd., Tokyo (JP)

(21) Appl. No.: 17/657,471

(22) Filed: Mar. 31, 2022

(30) Foreign Application Priority Data
Apr. 5, 2021 (JP) 2021-064036

(51) Int. Cl. G03G 9/097; G03G 15/08; G03G 9/08

(52) U.S. Cl. CPC G03G 9/09725; G03G 15/0865; G03G 9/0827; G03G 9/09716; G03G 9/09708

(57) ABSTRACT

[Object] An object of the invention is to provide a toner that can both achieve a higher level of low temperature fixability and suppression of the toner scattering.

[Means of Achieving the Object]

The disclosure is to provide a toner, including base-particles, and an external-additive, wherein a glass-transition temperature obtained from a DSC-curve at a second-warming of a THF-insoluble component is −50° C. or higher and 10° C. or lower, wherein an average circularity of the toner is 0.975 or more and 0.985 or lower, wherein the toner satisfies the following formula:

1.5≤Bt−0.025−Ct≤3.0,
wherein the Bt [m²/g] is a BET-specific-surface area of the toner-particles, and the Ct [%] is a coverage by the external-additive, and, at least a portion of a surface of the external-additive is coated with either an oxide of a metallic element, a hydroxide of the metallic element, or both.

### CROSS-REFERENCE TO RELATED APPLICATION

The present application is based on and claims priority to Japanese patent application No. 2021-064036, filed Apr. 5, 2021, with the Japanese Patent Office, the entire contents of which are hereby incorporated by reference.

### BACKGROUND OF THE INVENTION

### 1. Field of the Invention

The present invention relates to a toner, a developing agent, a toner housing unit, an image forming apparatus, and a method of forming images.

### 2. Description of the Related Art

Conventionally, latent images formed electrically or magnetically in an electrophotographic image forming apparatus or the like are visualized by a toner for electrophotography (hereinafter, referred to as “toner”). For example, in an electrophotographic method, an electrostatic charge image (latent image) is formed on a photoreceptor, and the latent image is developed by a toner to form toner images.

Toner images are normally transferred onto transfer materials, such as paper, and fixed to the transfer material. In the process of fixing the toner images on the transfer material, a heat fixing method, such as a heat roller fixing method or a heat belt fixing method, is widely used from the viewpoint of energy efficiency.

In recent years, the demand from the market for a faster and more energy-efficient image forming apparatus is increasing, and there is a need for a toner that can provide excellent low-temperature fixability and high-quality images. In order to achieve a low temperature fixability of the toner, there is a method of lowering a softening temperature of a toner binding resin.

However, when the softening temperature of the binding resin is low, a part of the toner image adheres to a surface of a fixing part during fixing, and an offset (also referred to as a hot offset) that is transferred to a copy paper is easily generated. In addition, the heat resistance of the toner deteriorates, and blocking occurs in which the toner particles fuse with each other under the high-temperature environment. In addition, there is a problem that the toner is fused to the inside of the developer or the carrier to cause contamination, and the toner easily films on the surface of the photoreceptor.

A number of technologies have been proposed in which crystalline resins and amorphous resins are combined to solve these problems (see, for example, Patent Documents 1 and 2). These materials have excellent compatibility between low temperature fixability and heat resistant storage property compared to a toner made of conventional amorphous resin. In addition, a crosslinked resin with a low softening temperature used as a binding resin to achieve both constant temperature fixability and heat resistant storage properties has been proposed (for example, see Patent Document 3).

In contrast, in recent years, demand for longer life and maintenance-free copiers is increasing, and suppression of toner contamination in a copying machine is required. One of the causes of toner contamination in the machine is toner scattering. As the charging capacity of the toner is not stable over time and the charging amount decreases, the toner is not sufficiently retained in the carrier, and toner in the developer is scattered, thereby causing internal contamination.

In the two-component developing method, when the toner component is released or adheres to the carrier over time, the charging performance of the toner is reduced, and in order to suppress this, an external additive such as titanium oxide, alumina, or the like is used, which has been proposed and widely used. Although there is a tendency to increase these external additives in response to the demand for suppressing higher toner scattering, external additives cause inhibition of toner fixing, and this is a problem to achieve higher level of low temperature fixability.

As a method of suppressing the toner scattering without decreasing the low temperature fixability, using a multifunctional external additive may be known. An external additive has been proposed in which silica particles are used as a substrate and an oxide or hydroxide of a metal element is coated on the surface thereof, thereby providing high fluidity and stabilizing the charge (see, for example, Patent Documents 4 and 5).

By using such an external additive, more than one type of external additive can be replaced by a single external additive. As a whole, the required toner performance can be realized with a smaller amount of external additive. Therefore, both low temperature fixability and suppression of toner contamination in a copying machine can be achieved to a certain extent.
[Patent Document 1] Japanese Patent No. 3949553
[Patent Document 2] Japanese Patent No. 4155108
[Patent Document 3] Japanese Patent No. 5408210
[Patent Document 4] Japanese Patent Application Laid-Open No. 2014-209254
[Patent Document 5] Japanese Patent Application Laid-Open No. 2019-109297

### SUMMARY OF THE INVENTION

When these external additives were used, the fluidity of the toner and the stability of the charge with respect to the environment were improved, however, the charging stability of the toner deteriorated over time, and the toner scattering worsened. The charging performance of the toner greatly deteriorates and the charging stability deteriorates with time when these external additives adhere to the carrier, it has been found that a higher level of low temperature fixability is not obtained with these external additives.

An object of the present invention is to provide a toner that can both achieve a higher level of low temperature fixability and suppression of the toner scattering.

### Means for Solving Problems

In order to solve the above-described problems, an aspect of the present invention is to provide a toner, including: base particles; and an external additive, wherein a glass transition temperature obtained from a DSC curve at a second warming of a THF-insoluble component is −50° C. or higher and 10° C. or lower, wherein an average circularity of the toner is 0.975 or more and 0.985 or lower, wherein the toner satisfies the following formula:

1.5≤Bt−0.025×Ct≤3.0,

wherein the Bt [m²/g] is a BET specific surface area, and the Ct [%] is a coverage by the external additive, and, wherein at least a portion of a surface of the external additive is coated with either an oxide of a metallic element, a hydroxide of the metallic element, or both, and further coated with an organic compound.

### Effects of the Invention

According to an aspect of the present invention, a toner that can both achieve a higher level of low temperature fixability and suppression of toner scattering can be provided.

### BRIEF DESCRIPTION OF THE DRAWINGS

FIG. 1 is a diagram illustrating an example of an image forming apparatus;

FIG. 2 is a diagram illustrating another example of the image forming apparatus;

FIG. 3 is a partially enlarged view illustrating an image forming apparatus of FIG. 2; and

FIG. 4 is a diagram illustrating an example of a process cartridge.

### DESCRIPTION OF THE PREFERRED EMBODIMENTS

Hereinafter, embodiments of the present invention will be described.

<Toner>

The toner according to the present embodiment includes base particles and an external additive.

[Base Particles]

The base particles represent particles that constitute the base (hereinafter, referred to as the base or toner base particle) that serve as the core of the toner. The toner base contains a binding resin as required. As the binding resin, the binding resin preferably includes an amorphous polyester resin A and a non-linear amorphous polyester resin B, and further preferably includes a crystalline polyester resin C.

The amorphous polyester resin A is preferably an unmodified amorphous polyester resin. The unmodified amorphous polyester resins can be prepared by reacting a polyhydric alcohol with a polycarboxylic acid.

Alternatively, anhydrides of polycarboxylic acids, lower alkyl esters having 1 to 3 carbon atoms, or halides may be used.

The polyhydric alcohol includes, but is not particularly limited to, diols and the like.

Examples of the diols include alkylene (carbon number 2 or more but not more than 3) oxide (average mole number 1 to 10) adducts of bisphenol A, such as polyoxypropylene (2.2)-2,2-bis(4-hydroxyphenyl) propane, polyoxyethylene (2.2)-2,2-bis(4-hydroxyphenyl) propane, and the like; ethylene glycol; propylene glycol; hydrogenated bisphenol A; alkylene (carbon number 2 to 3) oxide (average mole number 1 to 10) adducts of hydrogenated bisphenol A; and the like.

One of these diols may be used alone or in combination with two or more diols.

Examples of the polycarboxylic acids include, but are not particularly limited to, dicarboxylic acids and the like.

Examples of the dicarboxylic acids include adipic acid, phthalic acid, isophthalic acid, terephthalic acid, fumaric acid, maleic acid; succinic acids such as dodecenyl succinic acid, octyl succinic acid, in which a carbon number of 1 to 20 is substituted by an alkyl group or 2 to 20 is substituted by an alkenyl group.

One of these dicarboxylic acids may be used alone or in combination with two or more dicarboxylic acids.

The dicarboxylic acid preferably contains 50 mole or more of terephthalic acid. Accordingly, the heat-resistant storage performance of the toner can be improved.

The amorphous polyester resin A may include a constituent unit derived from carboxylic acids with a valence of three or more and/or alcohols with a valence of three or more at the terminal. Thus, the acid and hydroxyl group values of the amorphous polyester resin A can be adjusted.

Examples of the carboxylic acids with a valence of three or more include, but not particularly limited to, trimellitic acid, pyromellitic acid, and the like. The carboxylic acids with a valence of three or more may be used alone or in combination with two or more carboxylic acids with a valence of three or more.

Examples of the alcohols with a valence of three or more include, but are not limited to, glycerin, pentaerythritol, trimethylol propane, and the like. The alcohols with a valence of three or more may be used alone or in combination with two or more alcohols with a valence of three or more.

The weight average molecular weight of the amorphous polyester resin A is normally 5,000 or more and 20,000 or less, and preferably 6,000 or more and 15,000 or less. If the weight average molecular weight of the amorphous polyester resin A is 5,000 or more, the heat resistance and durability of the toner can be improved. If the weight average molecular weight of the amorphous polyester resin A is 20,000 or less, the low temperature fixability of the toner can be improved.

The acid value of the amorphous polyester resin A is normally 1 mgKOH/g or more and 50 mgKOH/g or less, and preferably 5 mgKOH/g or more and 30 mgKOH/g or less. If the acid value of the amorphous polyester resin A is 1 mgKOH/g or more, the toner tends to become negatively charged, and the low temperature fixability of the toner can be improved. If the acid value of the amorphous polyester resin A is 50 mgKOH/g or less, the charging stability of the toner (for example, the charging stability relative to the environmental change) can be improved.

The hydroxyl group value of amorphous polyester resin A is normally 5 mgKOH/g or more.

The glass transition temperature of the amorphous polyester resin A is normally 40° C. or higher and 80° C. or lower, and preferably 50° C. or higher and 70° C. or lower. As used herein, the glass transition temperature refers to the temperature at which the glass transition occurs. If the glass transition temperature of the amorphous polyester resin A is 40° C. or higher, the heat resistance, durability, and filming resistance of the toner can be improved. If the temperature is 80° C. or lower, the low temperature fixability of the toner can be improved.

The amount of amorphous polyester resin A contained in the toner is normally 50% by mass or more and 90% by mass or less, and preferably 60% by mass or more and 80h by mass or less. If the content of the amorphous polyester resin A in the toner is 50% by mass or more, the occurrence of the overload and distortion of the image can be suppressed. If the content of the amorphous polyester resin A in the toner is 90% by mass or less, the low temperature fixability of the toner can be improved.

The non-linear amorphous polyester resin B has a glass transition temperature that is very low below room temperature and deforms at low temperatures. In addition, the non-linear amorphous polyester resin B has the property of deforming against heating and pressure during fixing, making it easier to adhere to a paper at lower temperatures.

The amorphous polyester resin B preferably has a branched structure in the molecular backbone, and further preferably has a urethane bond and/or a urea bond. As a result, the amorphous polyester resin B has a high cohesive energy and has excellent adhesion to paper.

In addition, the amorphous polyester resin B has a rubber-like property in which the molecular chain is formed into a three-dimensional network by the branched structure in the skeleton and the pseudo-crosslinking point by the urethane bond and/or the urea bond, resulting in deformation at low temperature but not flowing. Therefore, the heat storage resistance and the high temperature offset resistance of the toner can be improved.

As described above, the amorphous polyester resin B has a glass transition temperature in an ultralow temperature range, but has a high melt viscosity. Therefore, by compositing the amorphous polyester resin B, which is difficult to flow, with other binding resins in a compatible state, both low temperature fixability and heat resistant storage performance of the toner can be achieved.

The amorphous polyester resin B is characterized by low solubility in organic solvents, high melt viscosity, and low brittleness, and thus granulation by dispersion in an aqueous medium or milling is generally difficult. Therefore, the amorphous polyester resin B is preferably added in the form of a prepolymer having a reactive group at the molecular end of the amorphous polyester and react while granulation.

The amorphous polyester resin B contains components derived from diols and components derived from dicarboxylic acids, but preferably further contains components derived from an acid with a valence of three or more and/or an alcohol with a valence of three or more. This allows for the development of rubber elasticity and the improvement of the resistance to blocking.

Here, the diol normally contains 50 mol % or more of an aliphatic diol having 3 to 10 carbon atoms.

Examples of the diols include, but are not limited to, aliphatic diols such as ethylene glycol, 1,2-propylene glycol, 1,3-propylene glycol, 1,4-butanediol, 3-methyl-1,5-pentanediol, 1,6-hexanediol, 1,8-octanediol, 1,10-decanediol, 1,12-dodecanediol, and the like; diols having oxyalkylene groups such as diethylene glycol, triethylene glycol, dipropylene glycol, polyethylene glycol, polypropylene glycol, polytetramethylene glycol, and the like; alicyclic diols such as 1,4-cyclohexanedimethanol, hydrogenated bisphenol A, and the like; alicyclic diols with alkylene oxides such as ethylene oxide, propylene oxide, butylene oxide, and the like; bisphenols such as bisphenol A, bisphenol F, bisphenol S, and the like; and alkylene oxide adducts of bisphenols such as those with added alkylene oxide such as ethylene oxide, propylene oxide, butylene oxide, and the like.

One of these diols may be used alone or in combination with two or more diols. Among them, aliphatic diols having 4 to 12 carbon atoms are preferably used.

The diol has an odd number of carbon atoms in the main chain and preferably has an alkyl group in the side chain. Accordingly, rubber elasticity can be developed while having high thermal deformability of the resin in the fixing temperature range, and low temperature fixability and blocking resistance of the toner can be improved.

Examples of the dicarboxylic acids include, but are not limited to, aliphatic dicarboxylic acids, aromatic dicarboxylic acids, and the like. One of these dicarboxylic acids may be used alone, or two or more dicarboxylic acids may be used in combination. Among them, aliphatic dicarboxylic acids having 4 to 12 carbon atoms are preferably used.

Alternatively, anhydrides of dicarboxylic acids, lower alkyl esters having 1 to 3 carbons, or halides may be used.

Examples of the aliphatic dicarboxylic acids include, but are not limited to, succinic acid, adipic acid, sebacic acid, dodecanoic acid, maleic acid, fumaric acid, and the like.

Examples of the aromatic dicarboxylic acids include phthalic acid, isophthalic acid, terephthalic acid, naphthalenedicarboxylic acid, and the like.

Examples of the acids or alcohols with a valence of three or more include, but are not limited to, glycerin, trimethylol ethane, trimethylol propane (TMP), pentaerythritol, sorbitol, dipentaerythritol, trimellitic acid (TMA), pyromellitic acid, and the like.

One of these acids or alcohols with a valence of three or more may be used alone, or two or more may be used in combination. Among them, acids or alcohols with a valence of three or more is preferable in that rubber elasticity can be developed while having high thermal deformability of resin in the fixing temperature range, and low temperature fixability and blocking resistance of toner can be improved.

The amorphous polyester resin B having a urethane bond and/or a urea bond can be synthesized by reacting a compound having an active hydrogen group with an amorphous polyester prepolymer resin B having an isocyanate group.

The amorphous polyester prepolymer resin B having an isocyanate group can be synthesized by reacting an amorphous polyester resin having an active hydrogen group with the polyisocyanate.

Examples of the polyisocyanates include, but are not particularly limited to, diisocyanate, isocyanate with a valence of three or more, and the like. One of these polyisocyanates may be used alone, or two or more of polyisocyanates may be used in combination.

Alternatively, the polyisocyanate may be blocked with a phenol derivative, oxime, caprolactam, or the like.

Examples of the diisocyanates include aliphatic diisocyanates, alicyclic diisocyanates, aromatic diisocyanates, aromatic aliphatic diisocyanates, isocyanurates, and the like.

Examples of the aliphatic diisocyanate include tetramethylene diisocyanate, hexamethylene diisocyanate, methyl 2,6-diisocyanatocaproate, octamethylene diisocyanate, decamethylene diisocyanate, dodecamethylene diisocyanate, tetradecamethylene diisocyanate, trimethylhexane diisocyanate, tetramethylhexane diisocyanate, and the like.

Examples of the alicyclic diisocyanates include isophorone diisocyanate, cyclohexylmethane diisocyanate, and the like.

Examples of the aromatic diisocyanates include trilene diisocyanate, diisocyanatodiphenylmethane, 1,5-naphthylene diisocyanate, 4,4′-diisocyanatodiphenyl, 4,4′-diisocyanato-3,3′-dimethyldiphenyl, 4,4′-diisocyanato-3-methyldiphenylmethane, 4,4′-diisocyanato-diphenyl ether, and the like.

Examples of the aromatic aliphatic diisocyanates include α,α,α′,α′-tetramethylxylylene diisocyanate and the like.

Examples of the isocyanurates include tris (isocyanatoalkyl) isocyanurate, tris (isocyanatocycloalkyl) isocyanurate, and the like.

Examples of the active hydrogen groups include, but are not particularly limited to, hydroxyl groups (alcoholic hydroxyl groups and phenolic hydroxyl groups), amino groups, carboxyl groups, mercapto groups, and the like. One of these active hydroxyl groups may be used alone, or two or more active hydrogen groups may be used in combination.

Compounds having an active hydrogen group are preferred because the compounds having the active hydrogen groups can form urea bonds.

Examples of the amines include, but are not limited to, diamines, amines with a valence of three or more, amino alcohols, aminomercaptans, amino acids, and the like. One of these amines may be used alone, or two or more amines may be used in combination.

A ketimine, oxazoline, or the like in which the amino group of the amine is blocked with ketones such as acetone, methyl ethyl ketone, methyl isobutyl ketone, or the like may be used instead of the amine.

Among these, a diamine, a mixture of the diamine and a small amount of an amine with a valence of three or more is preferably used.

Examples of the diamines include aromatic diamines, alicyclic diamines, aliphatic diamines, and the like.

Examples of the aromatic diamines include phenylenediamine, diethyltolueneamine, 4,4′-diaminodiphenylmethane, and the like.

Examples of the alicyclic diamines include 4,4′-diamino-3,3′-dimethyldicyclohexylmethane, diaminocyclohexane, isophorone diamine, and the like.

Examples of the aliphatic diamines include ethylene diamine, tetramethylene diamine, hexamethylene diamine, and the like.

Examples of the amines with a valence of three or more include diethylenetriamine, triethylenetetramine, and the like.

Examples of the amino alcohols include ethanolamine, hydroxyethyl aniline, and the like.

Examples of the aminomercaptans include aminoethyl mercaptan, aminopropyl mercaptan, and the like.

Examples of the amino acids include aminopropionic acid, aminocaproic acid, and the like.

The molecular structure of the amorphous polyester resin can be confirmed by NMR measurement using a solution or a solid, X-ray diffraction, GC/MS, LC/MS, IR measurement, or the like. Conveniently, an amorphous polyester resin without absorption based on δCH (out-of-plane deformation) of olefins at 965±10 cm⁻¹ and 990±10 cm⁻¹ in the infrared absorption spectrum can be detected.

The glass transition temperature Tg2nd determined from a differential scanning calorimetry (DSC) curve at the second warming of the amorphous polyester resin B is normally−60° C. or higher and 0° C. or lower. As used herein, differential scanning calorimetry curves indicate curves resulting from DSC.

If the Tg2nd of the amorphous polyester resin A is −60° C. or higher, the heat resistant storage property and the filming resistance of the toner can be improved. If the Tg2nd of the amorphous polyester resin A is 0° C. or lower, the low temperature fixability of the toner can be improved.

The weight average molecular weight of the amorphous polyester resin B is normally 20,000 or more and 1,000,000 or less, preferably 50,000 or more and 300,000 or less, and even more preferably 100,000 or more and 200,000 or less. If the weight average molecular weight of the amorphous polyester resin A is 20,000 or more, the heat storage resistance and the high temperature offset resistance of the toner can be improved. If the weight average molecular weight of the amorphous polyester resin B is 1,000,000 or less, the low temperature fixability of the toner can be improved.

The content of the amorphous polyester resin B contained in the toner is normally 51 by mass or more and 20% by mass or less, and preferably 51 by mass or more and 15% by mass or less. The content of the amorphous polyester resin B in the toner is 5% by mass or more, the low temperature fixability and the high temperature offset resistance of the toner can be improved. If the content of the amorphous polyester resin B in the toner is 20% by mass or less, the heat storage resistance of the toner and the gloss of the image can be improved.

Since a crystalline polyester C is highly crystalline, the crystalline polyester C exhibits a thermal melting characteristic in which the viscosity rapidly decreases around the starting of fixing temperature. For this reason, the crystalline polyester resin C and the toner containing the amorphous polyester resin B do not melt until immediately before the start of melting temperature. Therefore, the toner containing the amorphous polyester resin B is excellent in heat resistance storage.

In addition, at the start of melting temperature, the viscosity of the crystalline polyester resin C rapidly decreases due to melting, and the crystalline polyester resin C is compatible with the amorphous polyester resin B and fixes. Therefore, a toner having excellent heat storage resistance and low temperature fixability is obtained. Further, a width of mold release, that is, the toner having the difference between the lower limit temperature of fixing and the generation temperature of high temperature offset is obtained.

The crystalline polyester C is unmodified and can be synthesized by reacting a polyhydric alcohol with a polycarboxylic acid.

Alternatively, anhydrides of polycarboxylic acids, lower alkyl esters having 1 to 3 carbon atoms, or halides may be used.

Examples of the polyhydric alcohols include, but are not particularly limited to, diols and alcohols with a valence of three or more. One of these polyhydric alcohols may be used alone, or two or more of polyhydric alcohols may be used in combination.

Examples of the diols include saturated aliphatic diols and the like.

Examples of the saturated aliphatic diols include linear saturated aliphatic diols and branched saturated aliphatic diols. Among them, a linear chain saturated aliphatic diol is preferably used due to the high crystallinity of the crystalline polyester C, and a linear chain saturated aliphatic diol having 2 to 12 carbon atoms is further preferably used because it is readily available.

Examples of the saturated aliphatic diols include ethylene glycol, 1,3-propanediol, 1,4-butanediol, 1,5-pentanediol, 1,6-hexanediol, 1,7-heptanediol, 1,8-octanediol, 1,9-nonandiol, 1,10-decanediol, 1,11-undecanediol, 1,12-dodecanediol, 1,13-tridecanediol, 1,14-tetradecanediol, 1,18-octadecanediol, 1,14-eicosanediol, and the like.

Among them, ethylene glycol, 1,4-butanediol, 1,6-hexanediol, 1,8-octanediol, 1,10-decanediol, and 1,12-dodecanediol are preferably used because the crystalline property of the crystalline polyester C becomes high and the sharp melt property becomes excellent.

Examples of the alcohol with a valence of three or more include glycerin, trimethylol ethane, trimethylol propane, pentaerythritol, and the like.

Examples of the polyvalent carboxylic acids include, but are not particularly limited to, carboxylic acids with a valence of two or more and carboxylic acids with a valence of three or more.

Examples of the divalent carboxylic acid include saturated aliphatic dicarboxylic acids such as oxalic acid, succinic acid, glutaric acid, adipic acid, speric acid, azelaic acid, sebacic acid, 1,9-nonandicarboxylic acid, 1,10-decanedicarboxylic acid, 1,12-dodecanedicarboxylic acid, 1,14-tetradecandicarboxylic acid, 1,18-octadecanedicarboxylic acid, and the like; aromatic dicarboxylic acids such as phthalic acid, isophthalic acid, terephthalic acid, naphthalene-2,6-dicarboxylic acid, malonic acid, mesaconic acid, and the like.

Examples of the carboxylic acids with a valence of three or more include 1,2,4-benzenetricarboxylic acid, 1,2,5-benzenetricarboxylic acid, 1,2,4-naphthalenetricarboxylic acid, and the like.

The polyvalent carboxylic acid may include a dicarboxylic acid having a sulfonic acid group. The polycarboxylic acid may also contain a dicarboxylic acid having a carbon-carbon double bond.

The crystalline polyester C preferably has a constituting unit derived from a linear chain saturated aliphatic dicarboxylic acid having 4 to 12 carbon atoms and a constituting unit derived from a linear chain saturated aliphatic diol having 2 to 12 carbon atoms. As a result, the crystalline polyester C has a high crystallinity and excellent sharp melt property. As a result, the low temperature fixability of the toner can be improved.

The melting point of the crystalline polyester C is normally 60° C. or higher and 90° C. or lower, and preferably 60° C. or higher and 80° C. or lower. If the melting point of the crystalline polyester C is 60° C. or higher, the heat storage resistance of the toner can be improved. If the melting point of the crystalline polyester C is 90° C. or lower, the low temperature fixability of the toner can be improved.

The weight average molecular weight of crystalline polyester C is normally 3,000 or more and 30,000 or less, preferably 5,000 or more and 15,000 or less. If the weight average molecular weight of the crystalline polyester C is 3,000 or more, the heat storage resistance of the toner can be improved. If the weight average molecular weight of crystalline polyester C is 30,000 or less, the low temperature fixability of the toner can be improved.

The acid value of the crystalline polyester C is normally 5 mgKOH/g or more, and preferably 10 mgKOH/g or more. Therefore, the low temperature fixability of the toner can be improved. In contrast, if the acid value of crystalline polyester C is normally 45 mgKOH/g or less, the high temperature offset resistance of the toner can be improved.

The hydroxyl group value of the crystalline polyester C is normally 50 mgKOH/g or less, and preferably 5 mgKOH/g or more and 50 mgKOH/g or less. If the hydroxyl group value of the crystalline polyester C is 50 mgKOH/g or less, the low temperature fixability and the charging property of the toner can be improved.

Molecular structure of the crystalline polyester can be confirmed by NMR measurement using a solution or a solid, X-ray diffraction, GC/MS, LC/MS, IR measurement, or the like. Conveniently, an infrared absorption spectrum with absorption based on δCH of olefin at 965±10 cm⁻¹ or 990±10 cm⁻¹ can be detected as a crystalline polyester.

The content of the crystalline polyester C in the toner is normally 3% by mass or more and 20% by mass or less, preferably 5% by mass or more and 15% by mass or less. If the content of the crystalline polyester C in the toner is 3% by mass or more, the low temperature fixability of the toner can be improved. If the content of the crystalline polyester C in the toner is 20% by mass or less, the heat storage resistance of the toner can be improved, and at the same time, the generation of overlapping images can be suppressed.

The toner base further contains other components as needed. Examples of the other components include mold release agents, pigments, charge control agents, cleaning improvers, magnetic materials, and the like.

Examples of the mold release agents include, but are not limited to, plant-based waxes (for example, carnauba wax, cotton wax, wood wax, and rice wax), animal waxes (for example, beeswax, and lanolin), mineral-based waxes (for example, ozocerite and cercine), petroleum waxes (for example, paraffin, microcrystalline, and petrolatum), hydrocarbon-based waxes (for example, Fischer-Tropschwax, polyethylene wax, and polypropylene wax), synthetic waxes (for example, esters, ketones, and ethers), fatty amide compounds (for example, 12-hydroxystearate amide, stearate amide, and phthalic anhydride), and the like.

Among them, hydrocarbon-based waxes such as paraffin wax, microcrystalline wax, Fischer-Tropsch wax, polyethylene wax, polypropylene wax, and the like are preferably used.

One of these mold releasing agents may be used alone, or two or more mold releasing agents may be used in combination.

The melting point of the mold-releasing agent is normally 60° C. or higher and 80° C. or lower. If the melting point of the mold releasing agent is 60° C. or higher, the heat storage resistance of the toner can be improved. If the melting point of the toner is 80° C. or lower, the high temperature offset resistance of the toner can be improved.

The content of the mold releasing agent in the toner is normally 2% by mass or more and 10% by mass or less, and preferably 3% by mass or more and 8% by mass or less. If the content of the mold-releasing agent in the toner is 2% by mass or more, the high temperature offset resistance and the low temperature fixability of the toner can be improved. If the content of the toner is 10% by mass or less, the heat storage resistance of the toner can be improved and the generation of overlapping images can be suppressed.

Examples of the pigments include, but are not specifically limited to, carbon black, nigrosine dye, iron black, naphthol yellow S, Hansa yellow (10G, 5G, G), cadmium yellow, yellow iron oxide, yellow soil, yellow lead, titanium yellow, polyazoy yellow, oil yellow, Hansa yellow (GR, A, RN, R), pigment yellow L, benzidine yellow (G, GR), permanent yellow (NCG), Vulcan fast yellow (5G, R), tartrazine lake, quinoline yellow lake, anthrazan yellow BGL, isoindolinone yellow, bengala, red lead, lead vermilion, cadmium red, cadmium mercury red, antimony red, permanent red 4R, para-red, fire red, parachloro-ortho nitroaniline red, lysole fast scarlet G, brilliant carmine BS, permanent red (F2R, F4R, FRL, FRLL, F4RH), fast scarlet VD, Belcan fast rubin B, Brilliant Scarlet G, Lithorbin GX, Permanent Red F5R, Brilliant Carmine 6B, Pigment Scarlet 3B, Bordeaux 5B, Toluidine Maroon, Permanent Bordeaux F2K, Herioboldo BL, Bordeaux 10B, Bon Maroon Light, Bonn Maroon Medium, Eosin Lake, Rhodamine Lake B, Rhodamine Lake Y, Alizarin Lake, thioindigo Red B, thioindigo Maroon Maroon, oil Red, Kinacridone Red, Kinazolon Red, Polyazol Red, chrome vermilion, benzidine orange, perinone orange, oil orange, cobalt blue, cellurian blue, alkali blue lake peacock blue lake, Victoria blue, metalless phthalocyanine blue, phthalocyanine blue, indanthraquinone blue (RS, BC), indigo, group blue, dark blue, anthraquinone blue, fast violet B, methyl violet lake, cobalt purple, manganese purple, dioxane violet, anthraquinone violet, chrome green, zinc green, chromium oxide, pyridian, emerald green, pigment green B, naphthol green B, green gold, acid green lake, malachite green lake, phthalocyanine green, anthraquinone green, titanium oxide, zinc, lithophone, and the like.

One of these pigments may be used alone, or two or more of the pigments may be used in combination. The content of the pigment in the toner is normally 1% by mass or more and 15% by mass or less, and preferably 3% by mass or more and 10% by mass or less.

The pigments can also be composited with the resin and used as a master batch.

Examples of the resins include, but are not limited to, polymers of styrene or its substitute such as amorphous polyester resin B, polystyrene, poly p-chlorostyrene, polyvinyl toluene; styrene-based polymers such as styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-α-methyl chloromethacrylate copolymer, styrene-acrylonitrile copolymers, styrene-vinyl methyl ketone copolymers, styrene-isoprene copolymers, styrene-acrylonitrile-indene copolymers, styrene-maleic acid copolymers, styrene-maleic acid ester copolymers; polymethylmethacrylate, polybutylmethacrylate, polyvinyl chloride, polyvinyl acetate, polyethylene, polypropylene, polyester, epoxy resin, epoxy polyol resin, polyurethane, polyamide, polyvinyl butyral, polyacrylic acid, rosin, modified rosin, terpene resin, aliphatic or alicyclic hydrocarbon resin, aromatic petroleum resin, and the like.

One of these resins may be used alone, or two or more of resins may be used in combination.

The master batch can be manufactured by mixing and kneading the resin and the pigments. In this case, an organic solvent can be used to enhance the interaction between the pigments and the resin.

The master batch may also be prepared using a method known as the flushing process, in which an aqueous pigment paste is mixed and kneaded with a resin and an organic solvent to transfer the pigment to the resin side and remove water and the organic solvent. In this case, the pigment does not need to be dried because the pigment wet cake can be used as is.

Examples of the mixing and kneading apparatus include, but are not limited to, a high shear dispersion apparatus such as a three-roll mill and the like.

Examples of cleaning improvers include, but are not limited to, fatty acid metal salts such as zinc stearate, calcium stearate, and the like; polymer particles manufactured by soap-free emulsified polymerization such as polymethylmethacrylate particles, polystyrene particles, and the like.

One of these cleaning improvers may be used alone, or two or more cleaning improvers may be used in combination.

The volume average particle size of the polymer particles is normally 0.01 μm or more and 1 μm or less.

Examples of the magnetic materials include, but are not limited to, iron, magnetite, ferrite, and the like. White materials are particularly preferably used in terms of color tones. One of these magnetic materials may be used alone, or two or more magnetic materials may be used in combination.

[External Additives]

An external additive is an additive that is added to adhere to the outer surface of the toner base. In the present embodiment, at least a portion of the surface of the external additive is coated with either an oxide of a metallic element, a hydroxide of the metallic element, or both, and further coated with an organic compound. Hereinafter, the term “either an oxide of a metallic element, a hydroxide of a metallic element, or both” refers to an oxide of an elemental metal, a hydroxide of an elemental metal, or a mixture of an oxide of an elemental metal and a hydroxide of an elemental metal.

The components of the external additive are preferably, but not limited to, silica, and more preferably, silica particles.

The types of metallic elements used as an external additive as an oxide and/or a hydroxide are not particularly limited and include various metallic elements such as aluminum, zinc, calcium, magnesium, strontium, barium, titanium, zirconium, tin, iron, copper, and the like. One of these elements may be used alone, or two or more metallic elements may be used in combination.

Among these, when the external additive is silica, the metallic element is preferably at least one selected from aluminum, zinc, magnesium, and barium in order to reduce the high-volume resistance of the silica and further improve the properties (for example, hydrophobicity, volume resistivity, or the like) of the external additive.

The coating amount of oxide, hydroxide, or mixture thereof of the metallic element is preferably 1% by mass or more and 40% by mass or less on the basis of the mass of the external additive, and more preferably 5% by mass or more and 25% by mass or less on the basis of the mass of the external additive.

When the coating amount is less than 1% by mass, the surface of the toner base particles to be a substrate cannot be sufficiently coated, and when the external additive is silica, the high-volume resistance of the silica may not be sufficiently reduced. In contrast, if the coating amount is greater than 40% by mass, the fluidity of the external additive may be impaired.

The type of the organic compounds used as an external additive is not particularly limited to, but the organic compound is preferably treated with a silane coupling agent. Examples of the silane coupling agents include silane, hexamethyldisilazane, methyltrimethoxysilane, ethyltriethoxysilane, isobutyltrimethoxysilane, octyltrimethoxysilane, decyltrimethoxysilane, and the like.

Among these, alkylsilanes having 4 or less carbons are preferably used. For example, methyltrimethoxysilane, ethyltriethoxysilane, isobutyltrimethoxysilane, and the like are particularly preferred as alkylsilanes having 4 or less carbon atoms from the viewpoint of improving the fluidity of the external additive.

The external additive may optionally include metalloid oxides (for example, antimony oxide), oxides of non-metallic elements (for example, silicon oxide), fatty acid metal salts (for example, zinc stearate, aluminum stearate), fluoropolymers, and the like. One of these other components may be used alone, or two or more other components may be used in combination.

The external additive used in the toner of the present embodiment preferably has an average primary particle size of 15 nm or more and 50 nm or less. As used herein, the average primary particle size refers to the average value (number-based average primary particle size) of the primary particle size obtained from the transmission electron micrograph (TEM image) or scanning electron micrograph (SEM image) of the particles.

Since the average primary particle size of the external additive is 15 nm or more, it is possible to further prevent the oxide particles from being buried in the base particles. In addition, since the average primary particle diameter of the external additive is 50 nm or less, it is possible to provide fluidity by the toner.

As a method of manufacturing an external additive, for example, a method including coating at least a portion of the surface of the external additive with either an oxide of the metallic element, a hydroxide of the metallic element, or both, and further coating the portion with an organic compound, can be used.

For specific methods of coating treatment, known methods may be used, but the following methods may be used, for example.

First, the silica particles are dispersed in water, and an aqueous solution of an elemental water-soluble salt or an elemental water-soluble salt is added, then adjusted to a pH of 4 to 9 using an acid or base, and aged for a period of time. In this manner, hydrolysis of the water-soluble salt of the elemental metal occurs, and at least a portion of the surface of the silica particle is coated with the oxide and/or hydroxide of the elemental metal.

The aged slurry is then filtered and the residual on the filter medium is washed with water to form a wash cake, dried, and pulverized with a media pulverizer. The powder and the organic compound thus obtained are mixed in a small mixer and re-dried to obtain an external additive.

The toner of the present embodiment has a glass transition temperature (hereinafter, referred to as Tg2nd) of −50° C. or higher and 10° C. or lower, and preferably 30° C. or higher and 5° C. or lower, which is obtained from the DSC curve at the second warming of the tetrahydrofuran (THF)-insoluble component. If the Tg2nd is equal to or higher than −50° C., the decrease in the heat storage resistance of the toner can be suppressed. In addition, if the Tg2nd is 10° C. or lower, the decrease in the low temperature fixability of the toner can be suppressed.

The toner of the present embodiment has an average circularity of 0.975 or more and 0.985 or less, and preferably 0.980 or more and 0.985 or less. As used herein, the average circularity indicates the average value obtained by optically sensing the particles and dividing by the equivalent circumference length of the projected area.

The average circularity of conventional toner is normally 0.92 or more. In contrast, in the present embodiment, by setting the average circularity of the toner to be 0.975 or more and 0.985 or less, the cleaning property of the toner is improved, and the toner can be prevented from remaining in the photoreceptor.

Examples of the method of controlling the average circularity of the toner are not particularly limited, but include heat treatment, adjustment of the viscosity of the oil droplets, adjustment of the number of associations of the oil droplets, or the like.

The toner according to the present embodiment satisfies the formula 1.5 ≤Bt−0.025×Ct≤3.0 and preferably satisfies the formula 2.0≤Bt−0.025×Ct≤3.0, assuming that the Bt [m²/g] is a BET specific surface area and the coating ratio covered by the external additive is Ct [%]. Herein, the BET specific surface area refers to the specific surface area measured by the nitrogen gas adsorption BET method using a specific surface area measuring device.

When the value of Bt−0.025×Ct is 1.5 or more, the external additive is difficult to be released from the base toner particle, and the adhesion to the carrier is suppressed. Therefore, the charge amount can be prevented from decreasing over time. In addition, if Bt −0.025×Ct is 3.0 or less, it is assumed that the durability of the toner is improved and the generation of a streak-shaped color loss in the image is prevented.

The BET specific surface area of the toner is a value including irregularities on the surface of the base particles and irregularities on the surface of the external additive. Here, when the coating ratio of the toner coated with the external additive having the BET specific surface area of about 20 to 200 m²/g is Ct %, the amount of increase in the BET specific surface area of the toner relative to the BET specific surface area of the base particles is about 0.025×Ct [m²/g]. Accordingly, Bt−0.025×Ct allows estimation of the BET specific surface area of the base particles.

Bt−0.025×Ct is an indicator of the surface smoothness of the base particles because the BET specific surface area is superior to the measurement principle in detecting fine surface irregularities.

The method for controlling the surface smoothness of the base particles includes, but is not particularly limited to, control by a granulation method, heat treatment, and the like.

For example, in a method of obtaining toner particles by combining a plurality of oil droplets by a dissolution suspension method or an ester extension method, it is possible to increase fine irregularities and decrease surface smoothness by combining a plurality of smaller oil droplets. In addition, when the base particles do not aggregate with each other, that is, when the particles are dispersed in the water-based medium and are heated at a temperature below the glass transition temperature of the binder resin, the fine irregularities on the surface of the base particles decrease, and the surface smoothness of the base particles can be increased.

In the present embodiment, the average primary particle size of the toner is preferably 3.0 μm or more and 8.0 μm or less. When the average primary particle size of the toner is 3.0 μm or more, the non-electrostatic adhesion between the toner and the intermediate transfer object is reduced, thus improving the transfer efficiency. In addition, the toner and the carrier are easily mixed in the developer. On the other hand, if the average primary particle diameter of the toner is 8.0 μm or less, it can be appropriately developed in the electrostatic latent image, and a high-resolution and high-quality image can be obtained.

The method of manufacturing the toner is not particularly limited, but includes, for example, a dissolution suspension method and the like.

The toner is preferably manufactured by emulsifying or dispersing an oil phase containing an amorphous polyester prepolymer resin A having an isocyanate group, an amorphous polyester resin B, and, if necessary, a crystalline polyester resin C, a mold releasing agent, a pigment, or the like in an aqueous medium.

The aqueous medium preferably has resin particles dispersed.

Examples of the resin constituting the resin particles include, but are not limited to, vinyl resin, polyurethane, epoxy resin, polyester, polyamide, polyimide, silicon-based resin, phenolic resin, melamine resin, urea resin, aniline resin, ionomer resin, polycarbonate, and the like, provided that the resin can be dispersed in the aqueous medium.

One type of resin may be used alone or two or more resins may be used in combination as the resin constituting the resin particles. Among them, a vinyl resin, a polyurethane, an epoxy resin, and a polyester are preferably used because fine spherical resin particles are easily obtained.

The mass ratio of the resin particles to the aqueous medium is normally 0.005 to 0.1.

The aqueous medium includes, but is not particularly limited to, water, a solvent which can be miscible with water, and the like. One of these aqueous media may be used alone, or two or more aqueous media may be used in combination. Among them, water is preferably used.

Examples of solvents which can be miscible with water include, but are not limited to, alcohols, dimethylformamide, tetrahydrofuran, cellosolves, lower ketones, and the like.

Examples of alcohols include methanol, isopropanol, ethylene glycol, and the like.

Examples of lower ketones include acetone, methyl ethyl ketone, and the like.

The oil phase can be prepared by dissolving or dispersing a toner material containing an amorphous polyester prepolymer resin A having an isocyanate group, an amorphous polyester resin B, optionally a crystalline polyester resin C, a mold releasing agent, a pigment, and the like in an organic solvent.

The concentration of the solid content in the oil phase is not particularly limited, but preferably 30% by mass or more and 60% by mass or less. When the concentration of the solid content in the oil phase increases to an appropriate range, the viscosity of the oil droplets increases, thereby increasing the circularity of the oil droplets by suppressing the combination of the oil droplets, thereby controlling the circularity.

The boiling point of the organic solvent is normally less than 150° C. This allows easy removal of the organic solvent.

Examples of the organic solvent include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, and the like.

One of these organic solvents may be used alone, or two or more organic solvents may be used in combination. Among them, ethyl acetate, toluene, xylene, benzene, methylene chloride, 1,2-dichloroethane, chloroform, carbon tetrachloride, and the like are preferably used, and ethyl acetate is more preferably used.

When the oil phase is emulsified or dispersed in an aqueous medium, an amorphous polyester prepolymer resin A having an isocyanate group and a compound having an active hydrogen group are reacted to form an amorphous polyester resin A.

The amorphous polyester resin A can be formed by the following methods (1) to (3).

(1) A method of forming an amorphous polyester resin A includes emulsifying or dispersing an oil phase containing an amorphous polyester prepolymer resin A having an isocyanate group and a compound having an active hydrogen group in an aqueous medium, and extending and/or crosslinking the amorphous polyester prepolymer resin A having an isocyanate group with the compound having an active hydrogen group in the aqueous medium.

(2) A method of forming an amorphous polyester resin A includes emulsifying or dispersing an oil phase containing an amorphous polyester prepolymer resin A having an isocyanate group in an aqueous medium in which a compound having an active hydrogen group is added beforehand, and extending and/or crosslinking the amorphous polyester prepolymer resin A having an isocyanate group with the compound having an active hydrogen group in the aqueous medium.

(3) A method of forming an amorphous polyester resin A includes emulsifying or dispersing an oil phase containing an amorphous polyester prepolymer resin A having an isocyanate group in an aqueous medium, adding a compound having an active hydrogen group in the aqueous medium, and extending and/or crosslinking the amorphous polyester prepolymer resin A having an isocyanate group with the compound having an active hydrogen group from the interface of the particles in the aqueous medium.

When the amorphous polyester prepolymer resin A having an isocyanate group is subjected to an extension reaction and/or cross-linking reaction with the compound having an active hydrogen group from the particle interface, the amorphous polyester resin A is formed preferentially on the surface of the resulting toner, and a concentration gradient of the amorphous polyester resin A can be formed in the toner.

The time for reacting the amorphous polyester prepolymer resin A having an isocyanate group with the compound having an active hydrogen group is normally 10 minutes to 40 hours and preferably 2 to 24 hours.

The temperature at which the compound having an active hydrogen group reacts with the amorphous polyester prepolymer resin A having an isocyanate group is normally 0° C. or higher and 150° C. or lower and preferably 40° C. or higher and 98° C. or lower.

When an amorphous polyester prepolymer resin A having an isocyanate group is reacted with a compound having an active hydrogen group, a catalyst may be used.

Examples of the catalyst include, but are not limited to, dibutyltin laurate, dioctyltin laurate, and the like.

Examples of the method of emulsifying or dispersing the oil phase in the aqueous medium include, but are not limited to, a method of adding the oil phase to the aqueous medium and dispersing it by shearing force.

Examples of the dispersion device used to emulsify or disperse the oil phase in the aqueous medium include, but are not limited to, a slow shear type disperser, a high shear type disperser, a friction type disperser, a high-pressure jet type disperser, an ultrasonic disperser, and the like. Among them, a high-speed shearing dispersor is preferable because the particle size of the dispersion (oil drops) can be controlled to be 2 to 20 μm.

When a high-speed shear dispersion device is used, the speed is normally 1,000 rpm or higher and 30,000 rpm or lower, and preferably 5,000 rpm or higher and 20,000 rpm or lower. The dispersion time is normally between 0.1 and 5 minutes for a batch system. The dispersion temperature is normally 0° C. or higher to 150° C. or lower, and preferably 40° C. or higher to 98° C. or lower under pressure.

The mass ratio of the aqueous medium to the toner material is normally from 0.5 to 20, preferably from 1 to 10. If the mass ratio of the aqueous medium to the toner material is 0.5 or more, the oil phase can be well dispersed. If the mass ratio of the aqueous medium to the toner material is 20 or less, economical advantage can be obtained.

The aqueous medium preferably contains a dispersant. Thus, when the oil phase is emulsified or dispersed in an aqueous medium, the dispersion stability of the oil droplets can be improved, the base particles can be shaped as desired, and the particle size distribution can be narrowed.

Examples of the dispersants include, but are not limited to, surfactants, water-insoluble inorganic compound dispersants, polymer-based protective colloids, and the like. One of these dispersants may be used alone, or two or more dispersants may be used in combination. Among them, surfactants are preferably used.

Examples of the surfactants include anionic surfactants, cationic surfactants, nonionic surfactants, amphoteric surfactants, and the like. Among them, a surfactant having a fluoroalkyl group is preferably used.

Examples of the anionic surfactants include alkyl benzene sulfonates, α-olefin sulfonates, phosphates, and the like.

The aqueous medium may further contain a coagulant. Therefore, the BET specific surface area of the base toner particles can be increased, and the requirements of the particle shape of the base toner particles can be satisfied in the present embodiment.

The coagulant includes, but is not limited to, inorganic metal salts or bivalent or higher metal complexes. One of these coagulants may be used alone, or two or more coagulants may be used in combination. Among them, inorganic metal salts are preferably used.

Examples of the inorganic metal salts include sodium salts, magnesium salts, aluminum salts, and polymers thereof. Sodium salt is preferable from the viewpoint of easiness of controlling the toner particle size and shape. Examples of such sodium salts include sodium chloride, sodium sulfate, and the like.

The content of the coagulant in the aqueous medium is not particularly limited, but the solids content is preferably 1.2% by mass or more and 5.0% by mass or less, and the content is more preferably 1.23 by mass or more and 3.0% by mass or less.

After the oil phase is dispersed in the aqueous medium, the organic solvent is removed to form the base particles.

Examples of the method of removing the organic solvent include, but are not limited to, a method in which the aqueous medium in which the oil phase is dispersed is gradually heated up to vaporize the organic solvent in the oil droplets, and a method in which the aqueous medium in which the oil phase is dispersed is sprayed into a dry atmosphere to remove the organic solvent in the oil droplets.

The base particles may be washed and then heat treated. By heating the slurry in which the base toner particles are dispersed in the aqueous medium, the BET specific surface area of the base toner particles can be reduced. As the heating temperature, the temperature is preferably less than the glass transition temperature of the toner. When the temperature is higher than the glass transition temperature, the base toner particles may coagulate.

The base particles are preferably washed, heat-treated, and dried. In this case, the base particles may be classified. Specifically, a cyclone, decanter, centrifuge, or the like may be used to classify the particles by removing the fine particles from the base particles contained in the aqueous medium, or the dried base particles may be classified.

The toner can be manufactured by mixing the base particles with the external additive and, if necessary, with the charge controlling agent. At this time, by applying a mechanical impact force to the mixture, the desorption of the external additive from the surface of the base particles can be suppressed.

A method of applying a mechanical impact force to a mixture is not particularly limited. For example, a method of applying a mechanical impact force to a mixture by rotating a blade at a high speed may be used, although the method is not particularly limited. Alternatively, a method of applying a mechanical impact force to a mixture in which a mixture is injected into a fast-moving airstream and particles are impacted on an impingement plate or particles are impacted to each other to apply impact forces to the mixture.

A commercially available device for applying a mechanical impact force to the mixture may be used. Examples of the commercially available products include the angmill (manufactured by Hosokawa Micron Corporation), the Type I mill (manufactured by Nippon Pneumatic Mfg. Co., Ltd.) modified to reduce the grinding air pressure, the hybridization system (manufactured by Nara Machinery Co., Ltd.), the kryptron system (manufactured by Kawasaki Heavy Industries, Ltd.), and the like.

In the toner of the present embodiment, as described above, the glass transition temperature obtained from the DSC curve at the second warming of the THF-insoluble component is −50° C. or higher and 10° C. or lower, the average circularity of the toner is 0.975 to 0.985, and the formula 1.5≤Bt−0.025×Ct≤3.0 is satisfied. Accordingly, even if the external additive, in which at least a portion of the surface of the external additive is coated with either an oxide of a metallic element, a hydroxide of a metallic element, or both, and further coated with an organic compound, is used, the adhesion of the external additive to the carrier is suppressed so that the toner charging property does not decrease over time. Therefore, the toner scattering can be suppressed at higher level.

The adhesion of the external additive to the carrier occurs when the toner and the carrier are agitated and mixed in the developer, and the external additive contacts and transfers to the carrier. The average circularity of the toner represents the degree of the relatively large irregularity shape of the toner, and when the average circularity is high, the toner has fewer irregularities and is smaller.

When the concave portion is present in the toner, when the external additive adheres to and immobilizes the external additive on the toner base particle, the external additive cannot be sufficiently immobilized on the toner base particle because the external additive enters the concave portion. However, when the average circularity is 0.975 or more and 0.985 or less, the above problem can be suppressed, and the external additive agent is more uniformly immobilized on the base particles, thereby preventing adhesion to the carrier.

The formula 1.5≤Bt−0.025×Ct≤3.0 represents the BET specific surface area of the toner base particles, and when Bt−0.025×Ct is large, a large amount of fine toner irregularities is obtained. If the toner has many fine irregularities, the contact area of the external additive to the toner increases, and the external additive can be immobilized by the toner base particles. Therefore, the adhesion to the carrier can be suppressed.

The ester extension method is suitable for setting the circularity and Bt−0.025×Ct to the above-described range. First, in the case of toner such that the toner particles are coagulated and heat-fused as in an emulsion coagulation method, the heating temperature is equal to or more than the glass transition temperature. Therefore, in the process of fusing, the surface becomes smooth and the fine irregularities are eliminated, and the BET specific surface area of the toner base particles is reduced.

In addition, when the toner is manufactured by the mixing and pulverizing process, the degree of circularity cannot be increased. The present embodiment has been obtained by using the ester extension method to provide a property that exceeds the range of the circularity and the BET specific surface area of the base particles that have been conventionally studied.

On the other hand, if the glass transition temperature obtained from the DSC curve at the time of the second warming of the THF insoluble component is −50° C. or higher and 10° C. or lower, it indicates that the toner contains the crosslinking component with the low glass transition temperature, and the low temperature fixability can be greatly improved. However, in addition, it was found that the above-described range of circularity and Bt−0.025×Ct can greatly inhibit the adhesion of the external additive to the carrier in comparison with the case in which this component is not contained.

Although the reason for this is not clear, it is considered probable that a crosslinking component having a low glass transition temperature provided a moderate adhesion and elasticity to the surface of the toner base particle, thereby suppressing the release of the external additive from the surface of the toner base particle so that the external additive is maintained on the surface of the toner base particles.

The toner can be rendered fluid and electrically charged stable by using an external additive having at least a portion of the surface of the external additive coated with either an oxide of a metallic element, a hydroxide of a metallic element, or both, and further coated with an organic compound. Particularly, in the case where the external additive is made of silica or the like, the toner can be rendered to have excellent fluidity, but the charging stability of the toner is insufficient. On the other hand, the oxide or the hydroxide of the elemental metal, such as titanium oxide, alumina, and fine particles of zinc oxide alone have excellent charging stability, but the fluidity is insufficient.

On the other hand, in the present embodiment, when the surface of the external additive is coated with either an oxide of the metallic element, a hydroxide of the metallic element, or both, the external additive may have both fluidity and charge stability. Coating the external additive with organic compounds is necessary to impart hydrophobicity, but by choosing the length of the carbon chain appropriately, both hydrophobicity and fluidity can be achieved, resulting in a higher level of low temperature fixability and suppression of scattering toner.

<Developing Agent>

The developing agent of the present embodiment contains the above-described toner. The developing agent of the present embodiment may be a single-component developing agent or a two-component developing agent.

The developing agent of the present embodiment further contains, optionally, components such as a carrier and the like. The carrier is normally formed with a protective layer on a core material.

Examples of the core materials include, but are not limited to, a manganese-strontium-based material having a mass magnetization of 50 emu/g or more and 90 emu/g or less, a manganese-magnesium-based material having a mass magnetization of 50 emu/g or more and 90 emu/g or less, an iron having a mass magnetization of 100 emu/g or more, a highly magnetizing material such as a magnetite having a mass magnetization of 75 emu/g or more and 120 emu/g or less, a low magnetizing material such as a copper-zinc-based material having a mass magnetization of 30 emu/g or more and 80 emu/g or less, and the like.

One or more types of materials constituting these core members may be used alone, or two or more materials may be used in combination.

The volume average particle size of the core material is normally 10 μm or more and 150 μm or less, and preferably 40 μm or more and 100 μm or less.

The content of the carrier in the two-component developing agent is normally 90% by mass or more and 98% by mass or less and preferably 93% by mass or more and 97% by mass or less.

Fluidity of the developing agent can be assessed by measuring total energy using a powder rheometer. Here, a powder rheometer will be described.

Previously used parameters such as particle size and shape make it difficult to determine the precise fluidity of the particles because the fluidity of the particles is influenced by many factors rather than the fluidity of the liquids, solids, or gases.

Also, even if the factor to be measured (for example, particle size) to specify the fluidity is determined, determining the factor to be measured is difficult because in practice, there are cases that the factor has little effect on the fluidity, or it may be meaningful to measure only in combination with other factors.

Moreover, the fluidity of particles also varies markedly depending on external environmental factors. For example, in the case of liquids, fluctuations in the measurement environment do not cause a significant fluctuation in the fluidity of the particles, but the fluidity of the particles varies greatly depending on external environmental factors such as humidity and the state of the flowing gas. Because it is not clear which of these external environmental factors will affect which measurement factors, measurement under precise measurement conditions is actually not reproducible.

In addition, the angle of repose, bulk density, and the like have been used as indices for the fluidity of toner in the developing tank. However, these physical property values are indirect to fluidity, making it difficult to quantify and control fluidity.

On the other hand, since the powder rheometer can measure the total energy applied to the rotor blades of the measuring machine from the developing agent, it is possible to obtain the sum of the factors due to fluidity.

Accordingly, in the powder rheometer, as is conventional in the art, an item to be measured for a developing agent obtained by adjusting a property value or a particle size distribution of a surface can be determined, and the fluidity can be directly measured without finding and measuring the optimum property value for each item. As a result, the powder rheometer can be used to check the total energy to determine whether it is suitable as a developing agent for use in electrostatic charge development.

Manufacturing control of such a developing agent is very suitable for practical use as compared to conventional methods of indirectly controlling the fluidity of the developing agent. It is also easy to keep the measurement conditions constant, and the measurement values are highly reproducible. In other words, the method of identifying fluidity with total energy is simpler, more accurate, and more reliable than the conventional method.

The powder rheometer is a fluid measuring device that directly determines fluidity by simultaneously measuring the rotational torque and the vertical load by rotating the rotor blade spirally through the filled particles. By measuring both the rotational torque and the vertical load, it is possible to detect fluidity with high sensitivity, including the properties of the particles themselves and the influence of the external environment. In addition, since the total energy is measured while the state of the particle filling is constant, favorable reproducibility data can be obtained.

The total energy measured using a powder rheometer of a developing agent at a container volume of 25 mL, a propeller type rotor blade of tip speed of 10 mm/s, and a propeller type rotor blade of approach angle of −5° is normally 200 to 350 mJ and preferably 200 to 300 mJ.

Since the total energy of the developing agent is 200 mJ or more, the developing agent is spouted out from the vicinity of the developing agent carrier, thereby preventing contamination in the image forming apparatus. On the other hand, since the total energy of the developing agent is 350 mJ or less, the durability of the toner can be improved.

The total energy of the developing agent after stirring and mixing 30 g of the developing agent for 60 minutes with a rocking mill at a frequency of 700 rpm is normally 200 to 350 mJ and preferably 200 to 300 mJ.

Since the total energy of the developing agent after stirring and mixing is 200 mJ or more using the rocking mill, the developing agent is spouted out from the vicinity of the developing agent carrier, thereby further preventing contamination in the image forming apparatus. Meanwhile, since the total energy of the developing agent after stirring and mixing is 350 mJ or less using the rocking mill, the durability of the toner can be improved.

Developing agents are normally used in known containers.

Examples of the containers include, but are not limited to, containers having a container body, a cap, and the like.

The shape of the container body includes, but is not limited to, a cylindrical shape and the like.

The container body preferably has spiral-shaped-irregularities formed on the inner peripheral surface and rotates, thereby allowing the developing agent to move toward the outlet side, and some or all of the spiral-shaped irregularities have a bellows function.

The material of the main body of the container includes, but is not limited to, resins such as polyester, polyethylene, polypropylene, polystyrene, polyvinyl chloride, polyacrylic acid, polycarbonate, ABS resin, polyacetal, and the like.

The container containing the developing agent is easy to store, transport, or the like, and is easy to handle. Therefore, the container can be detachably mounted on a process cartridge, image forming apparatus, and the like, which will be described later, and used for replenishing the developing agent.

The developing agent can be applied to a known image forming apparatus and process cartridge that forms an image by an electrophotographic method such as a magnetic single-component developing method, a non-magnetic single-component developing method, a two-component developing method, or the like.

In the developing agent of the present embodiment, the toner described above is used, and the effect obtained by the toner described above is obtained as is. Specifically, since the toner described above is used by using the developing agent of the present embodiment, both a higher level of low temperature fixability and a suppression of scattering of the toner in the developing agent can be achieved.

<Toner Housing Unit>

The toner housing unit of the present embodiment accommodates the above-described toner. As used herein, the toner housing unit is a unit that has the function of housing a toner and contains the toner. Examples of the toner housing unit include a toner housing container, a developer, a process cartridge, or the like.

The toner housing container is a container housing the toner.

The developer has methods for accommodating and developing the toner.

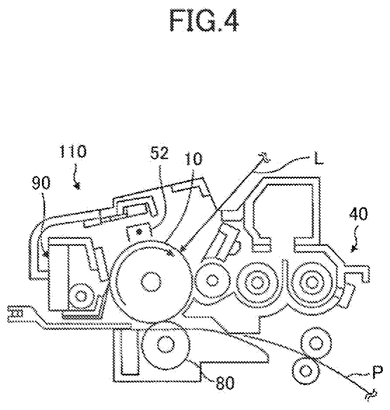

The process cartridge is at least integral with the image carrier and the developing unit, accommodates the toner, and can be detachably mounted to and from the image forming apparatus. The process cartridge may further include at least one selected from a charging method, an exposing method, and a cleaning method. A specific example of a process cartridge forming a part of the toner housing unit of the present embodiment is shown in FIG. 4, which will be described later.

In the toner housing unit of the present embodiment, the above-described toner is used, and the effect obtained by the above-described toner is obtained as is. Specifically, since the toner housing unit of the present embodiment is mounted to the image forming apparatus and an image is formed, the image is formed using the above-described toner. Therefore, both a higher level of low temperature fixability and a suppression of scattering of the toner can be achieved.

<Image Forming Apparatus>

The image forming apparatus of the present embodiment includes a photoreceptor, a charging part which charges the photoreceptor, an exposing unit which exposes the charged photoreceptor to form an electrostatic latent image, a developing part which develops an electrostatic latent image formed on the photoreceptor using the above-described toner to form a toner image, a transfer part which transfers a toner image formed on the photoreceptor to the recording medium, and a fixing part which fixes the toner image transferred to the recording medium.

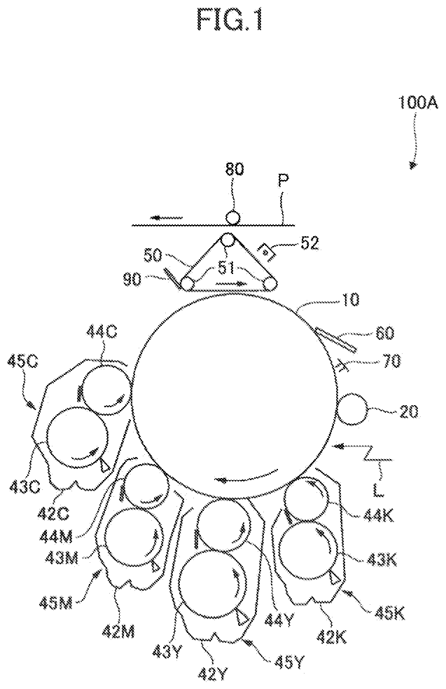

Specifically, the image forming apparatus of the present embodiment can be configured as an example of the image forming apparatus of the present exemplary embodiment illustrated in FIG. 1.

In FIG. 1, an image forming apparatus 100A includes a photoreceptor drum 10, a charging roller 20, an exposing device (not shown), a developer 45 (K, Y, M, and C), an intermediate transfer belt 50, a cleaning device 60 having a cleaning blade, and a static elimination lamp 70.

The intermediate transfer belt 50 is supported by three rollers 51 disposed on the inner side of the intermediate transfer belt and can be moved in the arrow direction. A portion of the three rollers 51 also functions as a transfer bias roller capable of applying a predetermined transfer bias to the intermediate transfer belt 50.

A cleaning apparatus 90 having a cleaning blade is disposed near the intermediate transfer belt 50. Further, a transfer roller 80 capable of applying a transfer bias for transferring the toner image to a recording paper P is disposed facing the intermediate transfer belt 50.

Around the intermediate transfer belt 50, a corona charger 52 that applies a charge to the toner image on the intermediate transfer belt 50 is disposed between a contact portion of the photoreceptor drum 10 and the intermediate transfer belt 50 and a contact portion of the intermediate transfer belt 50 and the recording paper P.

Each developer 45 of black (K), yellow (Y), magenta (M), and cyan (C) includes a developing agent housing member 42 (K, Y, M, and C), a developing agent supply roller 43 (K, Y, M, and C), and a developing roller 44 (K, Y, M, and C).

In the image forming apparatus 100A, after the photoreceptor drum 10 is uniformly charged by the charging roller 20, the exposing light L is irradiated onto the photoreceptor drum 10 by the exposing device (not shown) to form an electrostatic latent image. Next, the electrostatic latent image formed on the photoreceptor drum 10 is developed by supplying the developing agent (including the above-described toner) from the developer 45, and the toner image is transferred to the intermediate transfer belt 50 by the transfer bias applied from the roller 51.

The toner image on the intermediate transfer belt 50 is charged by the corona charger 52 and transferred onto the recording paper P. The toner remaining on the photoreceptor drum 10 is removed by the cleaning apparatus 60, and the photoreceptor drum 10 is once static eliminated by the static elimination lamp 70.

In the image forming apparatus 100A illustrated in FIG. 1, the photoreceptor drum 10, the charging roller 20, the exposing device, the developer 45, the intermediate transfer belt 50, and the transfer roller 80 of the image forming apparatus according to the present embodiment are examples of the photoreceptor, the charger (charging unit), the exposing unit, the developer (developing unit), the transferring unit, and the fixing unit, respectively.

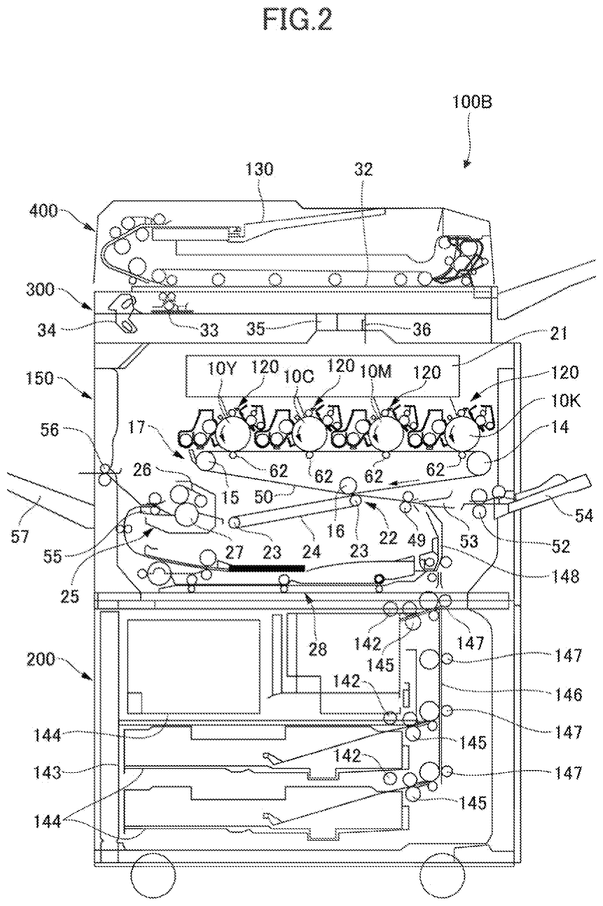

FIG. 2 illustrates another example of an image forming apparatus.

In FIG. 2, an image forming apparatus 100B is a tandem type color image forming apparatus and includes a main body of a copying machine 150, a paper-feed table 200, a scanner 300, and an automatic document feeder (ADF) 400.

The intermediate transfer belt 50 is disposed in the central portion of the main body of the copying machine 150.

The intermediate transfer belt 50 is supported by rollers 14, 15, and 16 and can rotate in the arrow direction.

A cleaning device 17 for removing residual toner on the intermediate transfer belt 50 is disposed near the support roller 15. In the intermediate transfer belt 50 supported by the roller 14 and the roller 15, four image forming units 120 of black (K), yellow (Y), magenta (M), and cyan (C) are disposed to face the intermediate transfer belt along the conveying direction.

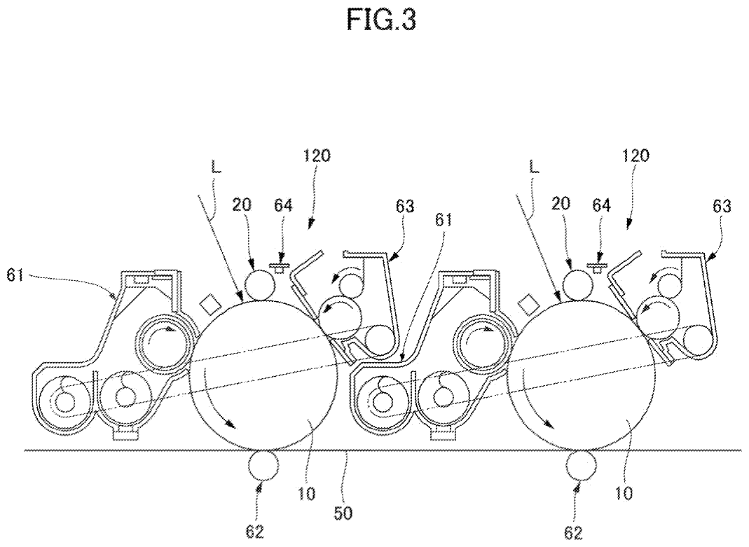

As illustrated in FIGS. 2 and 3, the image forming unit 120 of each color includes a photoreceptor drum 10, a charging roller 20 for uniformly charging the photoreceptor drum 10, a developer 61 for developing an electrostatic latent image formed on the photoreceptor drum 10 (K, Y, M, C) with a developing agent (including toner described above) of each color of black (K), yellow (Y), magenta (M), and cyan (C) to form a toner image, a transfer roller 62 for transferring the toner image of each color onto the intermediate transfer belt 50, a cleaning device 63, and a static elimination lamp 64.

Further, an exposing device 21 is disposed near the image forming unit 120. The exposing device 21 irradiates the exposing light L onto the photoreceptor drum 10 to form an electrostatic latent image.

Further, the transfer device 22 is disposed on the side opposite to the side in which the image forming unit 120 of the intermediate transfer belt 50 is disposed. The transfer device 22 is a transfer belt 24 supported by a pair of rollers 23, so that the recording paper conveyed on the transfer belt 24 and the intermediate transfer belt 50 can come into contact with each other.

In FIG. 2, a fixing device 25 is disposed near the transfer device 22. The fixing device 25 includes a fixing belt 26 and a pressing roller 27 that is pressed against the fixing belt 26.

Further, a reversing device 28 is disposed near the transfer device 22 and the fixing device 25 for inverting the recording paper in order to form an image on both sides of the recording paper.

Next, a formation of a full color image in the image forming apparatus 100B will be described. First, an original document is set on a document feeder 130 of the automatic document feeder (ADF) 400, or the ADF 400 is opened to set the original document on a platen glass 32 of the scanner 300, and the ADF 400 is closed.

Next, when an original document is set in the ADF 400 and a start button (not shown) is pressed, the original document is conveyed and moved onto the platen glass 32. Subsequently, the scanner 300 is driven and a first traveling body 33 and a second traveling body 34 travel. When an original document is set on the platen glass 32 and a start button (not shown) is pressed, the scanner 300 is immediately driven and the first traveling body 33 and the second traveling body 34 travel.

At this time, the light source from the first traveling body 33 emits light, and the reflected light from the surface of the original document reflects by a mirror in the second traveling body 34. Then, the light is received at a read sensor 36 through an imaging lens 35. Thus, the color document (the color image) is read, and image information of the respective colors of black, yellow, magenta, and cyan is obtained.

Further, the exposing device 21 forms an electrostatic latent image of each color on the photoreceptor drum 10 based on the image information of each color. The electrostatic latent image of each color is developed with a developing agent (including the above-described toner) supplied from the image forming unit 120 of each color, and a toner image of each color is formed. The toner image of each color is sequentially transferred to the intermediate transfer belt 50 which rotates by the rollers 14, 15, and 16, and a composite toner image is formed on the intermediate transfer belt 50.

In the paper-feed table 200, one of the paper feed rollers 142 is selectively rotated, and the recording paper is ejected from one of paper-feed cassettes 144 provided in multiple stages in a paper bank 143. Each paper of the extended recording papers is separated by a separating roller 145 and fed to a paper-feed passage 146, conveyed by a conveying roller 147, guided to a sheet-feed passage 148 inside the main body of the copying machine 150, and hit against a resist roller 49 to stop the paper.

Alternatively, the recording paper on the manual feed tray 54 is fed out, separated one by one by a separating roller 58, placed in a manual feed passage 53, and hit and stopped against the resist roller 49. The resist roller 49 is generally used in a state of ground, but may be used while a bias is applied to remove paper powder from the recording paper.

The resist roller 49 rotates by timing to the composite toner image formed on the intermediate transfer belt 50, feeds the recording paper between the intermediate transfer belt 50 and the transfer device 22, and transfers the composite toner image onto the recording paper.

The recording paper on which the composite toner image is transferred is conveyed by a transfer device 22 and delivered to a fixing device 25. In the fixing device 25, a fixing belt 26 and a pressure roller 27 fix the composite toner image on the recording paper by heating and pressurizing. Thereafter, the recording paper is switched by a switching claw 55 and ejected by an ejection roller 56 and stacked on an ejection tray 57.

Alternatively, the switching claw 55 is switched over and reversed by a reversing device 28 to be again guided to a transfer position, and an image is also formed on the back of the paper. Thereafter, the imaged formed paper is then ejected by an ejecting roller 56 and stacked on the ejection tray 57.

The toner remaining on the intermediate transfer belt 50 after the composite toner image is transferred is removed by the cleaning device 17.

In the image forming apparatus 100B illustrated in FIG. 2, the photoreceptor drum 10, the charging roller 20, the exposing device 21, the image forming unit 120, the intermediate transfer belt 50, and the fixing device 25 are examples of the photoreceptor, the charging unit, the exposing unit, the developing unit, the transferring unit, and the fixing unit, respectively of the image forming apparatus of the present embodiment.

FIG. 4 illustrates an example of a process cartridge as yet another example of an image forming apparatus.

The process cartridge 110 includes a photoreceptor drum 10, a corona charger 52, a developer 40, a transfer roller 80, and a cleaning device 90.

In FIG. 4, in the process cartridge 110, exposing light L is irradiated onto the photoreceptor drum 10 uniformly charged by the corona charger 52 by an exposing device (not shown) to form an electrostatic latent image. Next, an electrostatic latent image formed on the photoreceptor drum 10 is developed by supplying a developing agent (containing the toner described above) from the developer 40 to form a toner image. Subsequently, the transfer bias applied by the corona charger 52 forms the toner image on the photoreceptor drum 10.

The toner image formed on the photoreceptor drum 10 is transferred to a recording paper P by the transfer roller 80. The toner remaining on the photoreceptor drum 10 is removed by the cleaning device 90.

In the image forming apparatus 100B illustrated in FIG. 3, the photoreceptor drum 10, the corona charger 52, the exposing device, and the developer 40 are examples respectively of the photoreceptor, the charging unit, the exposing unit, and the developing unit of the image forming apparatus of the present embodiment. The photoreceptor drum 10 is also an example of a transfer portion of the image forming apparatus of the present embodiment. The transfer roller 80 is an example of a fixing part of the image forming apparatus of the present embodiment.

In the image forming apparatus of the present embodiment, the developing agent including the above-described toner is used, and the effect obtained by the above-described toner is obtained as is. Specifically, the image forming apparatus of the present embodiment is used. Since the image is formed using the developing agent including the toner, both a higher level of low temperature fixing and a suppression of scattering of the toner in the image forming can be achieved.

<Method of Forming Images>

The method of forming images in the present embodiment includes charging a photoreceptor, exposing the charged photoreceptor to form an electrostatic latent image, developing the electrostatic latent image formed on the photoreceptor using the above-described toner to form a toner image, transferring the toner image formed on the photoreceptor to a recording medium, and fixing the toner image transferred to the recording medium.

The method of forming images of the present embodiment is realized by implementing each example of the image forming apparatus illustrated in FIGS. 1, 2, and 3.

Specifically, in the image forming apparatus 100A of FIG. 1 and the image forming apparatus 100B of FIG. 2, charging process is performed in the photoreceptor drum 10 and the charging roller 20 in the respective apparatus, and the photoreceptor is then charged. In the process cartridge 110 of FIG. 3, charging is performed in the photoreceptor drum 10 and the corona charger 52, and the photoreceptor is then charged.

In the image forming apparatus 100A in FIG. 1 and the process cartridge 110 in FIG. 3, the exposing process is performed in the respective exposing device, and the electrostatic latent image is formed by exposing the charged photoreceptor. In the image forming apparatus 100B of FIG. 2, an electrostatic latent image is formed by exposing the charged photoreceptor in the exposing device 21.

In the image forming apparatus 100A illustrated in FIG. 1, the developing process is performed in the developer 45, and an electrostatic latent image formed on the photoreceptor is developed using the toner described above, and a toner image is then formed. Further, in the image forming apparatus 100B of FIG. 2, the developing process is performed in the image forming unit 120. In the process cartridge 110 of FIG. 3, the developing process is performed in the developer 40, and an electrostatic latent image formed on the photoreceptor is developed using the toner described above, and a toner image is then formed. formed.

In the image forming apparatus 100A in FIG. 1 and the image forming apparatus 100B in FIG. 2, the transfer process is performed in the respective intermediate transfer belt 50, and the toner image formed on the photoreceptor is transferred to a recording medium. In the process cartridge 110 of FIG. 3, the transfer process is performed in the photoreceptor drum 10, and the toner image formed on the photoreceptor is transferred to a recording medium.

In the image forming apparatus 100A in FIG. 1 and the process cartridge 110 of FIG. 3, the fixing process is performed in the respective transfer rollers 80, and the transferred toner image is fixed to a recording medium. In the image forming apparatus 100B of FIG. 2, the transferred toner image, which is performed by the fixing device 25, is fixed to the recording medium.

In the method of forming images of the present embodiment, the developing agent including the above-described toner is used, and the effect obtained with the above-described toner is obtained as is. Specifically, when the method of forming images of the present embodiment is used, the image forming is performed using the developing agent including the above-described toner. Therefore, both a higher level of low temperature fixability and a suppression of toner scattering in the image forming can be achieved.

### EXAMPLES

Although the present invention will be described in further detail with reference to the following examples, the present invention is not limited to these examples. “Parts” and “%” are, unless otherwise noted, mass standards. In addition, various tests and evaluations shall be conducted in accordance with the following methods.

[Manufacture of Toner]

A specific manufacturing example of the toner used in the evaluation will be described. The toner used in the present invention is not limited to these examples.

(Synthesis of Ketimine)

In a reaction vessel set with a stirrer and a thermometer, 170 parts of isophorone diamine and 75 parts of methyl ethyl ketone were charged and reacted at 50° C. for 5 hours to obtain ketimine compound 1. The ketimine compound 1 indicated an amine value of 418 mgKOH/g.

(Synthesis of Amorphous Polyester Resin A)

Two moles of ethylene oxide adduct (BisA-EO) of bisphenol A, three moles of propylene oxide adduct (BisA-PO), trimethylol propane (TMP), terephthalic acid, and adipic acid of bisphenol A were charged into a reaction vessel having a nitrogen introduction tube, a dehydration tube, a stirrer, and a thermocouple.

At this time, the molar ratio of BisA-PO, BisA-EO, and TMP was set as 38.6/57.9/3.5, the molar ratio of terephthalic acid and adipic acid was set as 85/15, the molar ratio of the hydroxyl group to the carboxyl group was set as 1.12, and 500 ppm of titanium tetraiisopropoxide was added to all monomers.

The mixture was then allowed to react at 230° C. for 8 hours and then allowed to react at 10 to 15 mmHg under reduced pressure for 4 hours. Furthermore, 1% by mol of trimellitic anhydride was added to all monomers, followed by reacting the mixture at 180° C. for 3 hours to obtain amorphous polyester resin A. The amorphous polyester resin A had a glass transition temperature of 61° C. and a weight average molecular weight of 13,000.

The melting point, glass transition temperature, and weight average molecular weight were determined as follows.

[Melting Point and Glass Transition Temperature]

Melting point and glass transition temperature were measured using a differential scanning calorimeter (TA Instrument, Q-200). Specifically, approximately 5.0 mg of a target sample was placed in an aluminum sample container, and the sample container was loaded into a holder unit and set into an electric furnace. Next, the temperature was increased from −80° C. to 150° C. under a nitrogen atmosphere at a temperature rise rate of 10° C./min.

From the obtained DSC curves, the glass transition temperature of the target sample was determined using an analysis program in a differential scanning calorimeter. The obtained DSC curve was used to calculate the endothermic peak top temperature of the target sample as the melting point using the analysis program in the differential scanning calorimeter.

[Weight Average Molecular Weight]

A GPC analyzer (HLC-8220 GPC, manufactured by Tosoh Corporation) and a column (TSKgel, SuperHZM-H, 15 cm, 3 sets, manufactured by Tosoh Corporation) were used to determine the weight average molecular weight. Specifically, the columns were stabilized in a 40° C. heat chamber.

Tetrahydrofuran (THF) was then passed through the column at a flow rate of 1 mL/min and 50 to 200 μL of a 0.05 to 0.6% by mass of the sample of THF solution was injected to determine the weight average molecular weight of the sample. At this time, the weight average molecular weight of the sample was calculated from the relationship between the logarithmic value of the calibration curve created using several monodisperse polystyrene standard samples and the number of counts.

As standard polystyrene samples, 6×102, 2.1×103, 4×103, 1.75×104, 5.1×104, 1.1×105, 3.9×105, 8.6×105, 2×106, and 4.48×106 (manufactured by Pressure Chemical or Tosoh Corporation) were used. As a detector, a RI (refractive index) detector was used.

(Synthesis of Amorphous Polyester Prepolymer Resin B-1)

3-methyl-1,5-pentanediol, adipic acid, and trimellitic anhydride were charged into a reaction vessel set with a cooling tube, a stirrer, and a nitrogen introduction tube. At this time, the molar ratio of the hydroxyl group to the carboxyl group was set as 1.5, the content of trimellitic anhydride in the total monomer was set as 1% by mol, and 1000 ppm of titanium tetraiisopropoxide was added to the total monomer.

Next, the temperature was raised to 200° C. for about 4 hours, then the temperature was raised to 230° C. for about 2 hours, and the reaction was allowed to proceed until the water did not flow out. Then, the reaction was allowed to proceed for 5 hours under a reduced pressure of 10 to 15 mmHg to obtain an amorphous polyester resin having a hydroxyl group.

The amorphous polyester resin with a hydroxyl group and isophorone diisocyanate were charged into a reaction vessel with a cooling tube, a stirrer, and a nitrogen introduction tube set. At this time, the molar ratio of the isocyanate group to the hydroxyl group was set as 2.0. Next, dilution with ethyl acetate was allowed to react at 100° C. for 5 hours to obtain a 50% ethyl acetate solution of amorphous polyester prepolymer resin B-1.

The 50% ethyl acetate solution of the amorphous polyester prepolymer resin B-1 was charged into a reaction vessel set with a heater, a stirrer, and a nitrogen introduction tube, stirred, and then ketimine compound 1 was added dropwise. At this time, the molar ratio of the amino group to the isocyanate group was set to 1.

Then, after stirring at 45° C. for 10 hours, the ethyl acetate was dried under reduced pressure at 50° C. until the residual amount of ethyl acetate was 100 ppm or less, and the amorphous polyester resin B-1 was obtained. The amorphous polyester resin B-1 had a glass transition temperature of −55° C. and a weight average molecular weight of 130,000.

(Synthesis of Amorphous Polyester Prepolymer Resin A-2)

The synthesis of amorphous polyester prepolymer resin A-2 was performed in the same manner as “Synthesis of Amorphous Polyester Prepolymer Resin A-1 ” except that isophthalic acid was used instead of adipic acid to obtain a 50% ethyl acetate solution of an amorphous polyester prepolymer resin A-2 and an amorphous polyester resin A-2. The amorphous polyester resin A-2 had a glass transition temperature of 5° C. and a weight average molecular weight of 120,000.

(Synthesis of Crystalline Polyester C)

Sebacic acid and 1,6-hexanediol were charged into a reaction vessel set with a nitrogen introduction tube, a dehydration tube, a stirrer, and a thermocouple. At this time, the molar ratio of the hydroxyl group to the carboxyl group was set as 0.9, and 500 ppm of titanium tetraiisopropoxide was added to all the monomers.

The reaction was then allowed to react at 180° C. for 10 hours, then warmed to 200° C. for 3 hours. Additionally, the reaction was carried out under reduced pressure at 8.3 kPa for 2 hours to obtain crystalline polyester C-1. The crystalline polyester C-1 had a melting point of 67° C. and a weight average molecular weight of 25,000.

(Preparation of Inorganic External Additive A)

First, 100 g of silica particles (SP-200 nip seal, BET specific surface area 200 m²/g, manufactured by Tosoh Silica Corporation) manufactured by the liquid phase method was dispersed in 2 L of water and heated to 85° C. Next, an aqueous aluminum chloride solution was added to the silica particles in an amount equivalent to 10% by mass of Al₂O₃, adjusted to pH 5.5 with aqueous sodium hydroxide, held with stirring for 30 minutes, and a clean cake was obtained by filtering and washing the residue on the filter medium with water.

The clean cake was then dried at 120° C. and ground with a media milling machine. Finally, 40 g of the resulting powder was charged into a small mixer, 10 g of decyltrimethoxysilane was added and mixed for 15 minutes, and then re-dried at 120° C. to prepare an inorganic mineral exterior additive A.

(Preparation of Inorganic External Additive B) First, 100 g of silica particles (SP-200 nip seal, BET specific surface area 200 m²/g, manufactured by Tosoh Silica Corporation) manufactured by the liquid phase method was dispersed in 2 L of water and heated to 85° C. Next, a zinc chloride aqueous solution was added to the silica particles in an amount equivalent to 10 by mass of ZnO, adjusted to pH 8.0 with aqueous sodium hydroxide, held while stirring for 30 minutes, and a clean cake was obtained by filtering and washing the residue on the filter medium with water.

The clean cake was then dried at 120° C. and ground with a media milling machine. Finally, 40 g of the resulting powder was charged into a small mixer, 10 g of decyltrimethoxysilane was added and mixed for 15 minutes, and then re-dried at 120° C. to produce an inorganic external additive B.

(Preparation of Inorganic External Additive C)

An inorganic external additive C was prepared in the same manner as the inorganic external additive A, except that isobutyltrimethoxysilane was used instead of decyltrimethoxysilane.

(Preparation of Inorganic External Additive D)

An inorganic external additive D was prepared in the same manner as the inorganic external additive A, except that aqueous aluminum chloride solution was not added (including adjustment to pH 5.5 and stirring for 30 minutes).

[Average Primary Particle Size]

SEM images of inorganic external additives were obtained using a field emission scanning electron microscope (SU8230, manufactured by Hitachi High-Tech, Ltd.) and the number average particle size was measured by image analysis. First, the inorganic external additive was dispersed in tetrahydrofuran, and the solvent was removed on the substrate to dryness. The sample was observed with the SEM described above to obtain an image and the maximum length of the primary particles was measured for each particle. The average of 50 particles was calculated as the average primary particle size.

An example of SEM measurement conditions is explained below.

[SEM Measurement Conditions]

Acceleration voltage: 2.0 kV

Working distance (WD): 5.0 mm

Observation magnification: 100000×

The conditions of the inorganic exterior additives A to D are indicated in Table 1.

| Inorganic external additive | | | A | B | C | D |
|---|---|---|---|---|---|---|
| Metallic element | Type | — | Al | Zn | Al | — |
| | Coating amount | % by | 10 | 10 | 10 | — |
| | oxide) | | | | | |
| Organic | Type | — | decyl- | decyl- | isobutyl- | decyl- |
| compound | | | trimethoxysilane | trimethoxysilane | trimethoxysilane | trimethoxysilane |
| | Coating amount | % by | 20 | 20 | 20 | 20 |
| | | mass | | | | |
| Physical property | Average primary | nm | 16 | 15 | 17 | 15 |
| | particle size | | | | | |

(Synthesis of Wax Dispersant 1)

100 parts of polyethylene (SANWAX 151-P, manufactured by Sanyo Chemical Industies, Ltd.) with a melting point of 108° C. and a weight average molecular weight of 1,000 was charged into an autoclave reactor with a thermometer and a stirrer set, and then polyethylene was dissolved and nitrogen was replaced.

Then, a mixture of 805 parts of styrene, 50 parts of acrylonitrile, 45 parts of butyl acrylate, 36 parts of di-t-butyl peroxide, and 100 parts of xylene was added dropwise at 170° C. for 30 minutes. Further, the solvent was removed to obtain a wax dispersant 1. The wax dispersant 1 had a glass transition temperature of 65° C. and a weight average molecular weight of 18,000.

(Preparation of Wax Dispersion Liquid 1) 300 parts of paraffin wax (HNP-9, manufactured by NIPPON SEIRO Co., Ltd.) having a melting point of 75° C., 150 parts of wax dispersant 1, and 1800 parts of ethyl acetate were charged into a vessel with a stirrer and a thermometer.

Then, the temperature was raised to 80° C. with stirring, kept for 5 hours, and then cooled to 30° C. in 1 hour. Furthermore, a bead mill (Ultravisco Mill, manufactured by IMEX Co., Ltd.) was used to fill 80% by volume of zirconia beads with a diameter of 0.5 mm, and dispersed under three passes to obtain the wax dispersion liquid 1. At this time, the flow rate was set to 1 kg/h and the circumferential speed of the disk was set to 6 m/s.

(Preparation of Pigment Master Batch)

1200 parts of water, 500 parts of Carbon black (Printex 35, manufactured by Degussa AG) having 42 mL/100 mg of DBP oil absorption and pH of 9.5, and 500 parts of the amorphous polyester resin A were mixed with a Henschell mixer (manufactured by Japan Coke Industry Co., Ltd.), and then kneaded using two rolls at 150° C. for 30 minutes. After cooling by press-rolling the mixture, the mixture was pulverized by a pulverizer to obtain a pigment master batch 1.

(Preparation of Crystalline Polyester Dispersion 1)

308 parts of the crystalline polyester C and 1900 parts of ethyl acetate were charged into a vessel equipped with a stirrer and thermometer. Then, the temperature was raised to 80° C. with stirring, kept for 5 hours, and then cooled to 30° C. in 1 hour.

Furthermore, 80% by volume zirconia beads with a diameter of 0.5 mm was filled with use of a bead mill (Ultravisco Mill, manufactured by IMEX Co., Ltd.), and the zirconia beads were dispersed under three passes to obtain a crystalline polyester dispersion 1. At this time, the flow rate was set to 1 kg/h and the circumferential speed of the disk was set to 6 m/s.

(Preparation of Oil Phase 1)

After charging 320 parts of the amorphous polyester resin A, 100 parts of the 50% ethyl acetate solution of amorphous polyester prepolymer resin B-1, 210 parts of the crystalline polyester dispersion 1, 220 parts of the wax dispersion 1, 60 parts of the pigment master batch 1, and 285 parts of ethyl acetate into a container, the mixture was mixed with use of a TK homomixer (manufactured by Primix, Inc.) at 7000 rpm for 60 minutes to obtain an oil phase 1.

(Synthesis of Vinyl Resin Dispersion Liquid 1) 683 parts of water, 11 parts of sodium salt of the sulfate ester of the ethylene oxide adduct of methacrylic acid (ELEMINOL (Registered Trademark) RS-30, manufactured by SANYO CHEMICAL, Ltd.), 138 parts of styrene, 138 parts of methacrylic acid, and 1 part of ammonium persulfate were charged into a reaction vessel equipped with a stirrer and a thermometer, and the mixture was then stirred at 400 rpm for 15 minutes to obtain a white emulsion.

Next, the temperature in the system was raised to 75° C. and allowed to react for 5 hours, 30 parts of a 1 aqueous ammonium persulfate solution was added and aged at 75° C. for 5 hours to obtain a vinyl resin dispersion 1. The volume average particle size of the vinyl resin dispersion liquid 1 was 0.14 μm.

The volume average particle size of the vinyl resin dispersion liquid 1 was measured using a laser diffraction/scattering particle size distribution measuring device (LA-920, manufactured by HORIBA Ltd.).

(Preparation of Water Phase 1) 990 parts of water, 83 parts of a vinyl resin dispersion liquid 1, 48.5% aqueous solution of sodium dodecyl diphenyl ether disulfonate (ELEMINOL (Registered Trademark) MON-7, manufactured by SANYO CHEMICAL, Ltd.), and 90 parts of ethyl acetate were mixed and stirred to obtain a milky white aqueous phase 1.

[Emulsification and Solvent Removal]

0.2 parts of ketimine 1 and 600 parts of water phase 1 were added to a vessel containing 400 parts of the oil phase 1, followed by stirring 1 to 3 below using a TK homomixer to obtain an emulsified slurry 1.

Agitation 1: mix at 8000 rpm for 2 minutes

Agitation 2: mix at 2000 rpm for 1 minute

Agitation 3: mix at 500 rpm for 20 minutes

The emulsion slurry 1 was charged into a vessel equipped with a stirrer and a thermometer, the solvent was removed at 30° C. for 8 hours, and then aged at 45° C. for 4 hours to obtain a dispersion slurry 1.

[Cleaning, Heat Treatment, Drying]

100 parts of the dispersion slurry 1 was filtered under reduced pressure. Then, 100 parts of ion-exchanged water was added to the filter cake, mixed with a TK homomixer at 12000 rpm for 10 minutes, and then filtered (hereinafter referred to as washing step (1)).

In addition, 100 parts of a 101 aqueous sodium hydroxide solution was added to the filter cake, mixed with a TK homomixer at 12000 rpm for 30 minutes, and then filtered under reduced pressure (hereinafter referred to as washing step (2)).

Then, 100 parts of 10% hydrochloric acid was added to the filter cake, mixed with a TK homomixer at 12000 rpm for 10 minutes, and then filtered (hereinafter referred to as washing step (3)).

In addition, 300 parts of ion-exchanged water was added to the filter cake, mixed with a TK homomixer at 12000 rpm for 10 minutes, and then filtered (hereinafter referred to as washing step (4)). At this time, the washing steps (1) to (4) were repeated twice.

100 parts of ion-exchanged water was added to the filter cake, mixed with a TK homomixer at 12000 rpm for 10 minutes, heated at 50° C. for 15 minutes, and then filtered.

The filtered cake was dried at 45° C. for 48 hours using a recirculating air dryer, and then screened with a mesh with an eye opening of 75 μm to obtain base particles.

[External Additive Mixture]

### Example 1

100 parts of the toner base particles 1 was mixed with 2.0 parts of hydrophobic silica (UFP (Registered Trademark)-35, manufactured by Denka Company Limited), 1.5 parts of hydrophobic silica (NX-90G, manufactured by Aerosol Japan) and 1.0 parts of the inorganic external additive A were mixed with a Henschel mixer, and the mixture was passed through a 500-mesh screen to obtain a toner 1.

### Example 2

Example 2 was performed in the same manner as Example 1 to obtain a toner 2, except that 180 parts of ethyl acetate in the preparation of the oil phase 1 in Example 1 was changed to 100 parts and the agitation 2 was not performed among the agitations 1 to 3.

### Example 3

Example 3 was performed in the same manner as Example 1 to obtain a toner 3, except that 990 parts of water in the preparation of the water phase 1 was changed to 870 parts of water and 120 parts of 10% aqueous solution of sodium hydroxide was added.

### Example 4

Example 4 was performed in the same manner as Example 1 to obtain a toner 4, except that 990 parts of water in the preparation of the aqueous phase 1 was changed to 810 parts of water, 180 parts of 101 aqueous solution of sodium hydroxide was added, and the temperature of washing and heating treatment in the preparation of the aqueous phase 1 was changed from 50° C. for 15 minutes to 50° C. for 0 minute.

### Example 5

Example 5 was performed in the same manner as Example 2 to obtain a toner 5, except that the agitation 2 in the emulsification and solvent removal was performed.

### Example 6

Example 6 was performed in the same manner as Example 5 to obtain a toner 6, except that 180 parts of ethyl acetate in the preparation of the oil phase 1 was changed to 100 parts of ethyl acetate.

### Example 7

Example 7 was performed in the same manner as Example 3 to obtain a toner 7, except that 180 parts of ethyl acetate in the preparation of the oil phase 1 of Example 3 was changed to 50 parts of ethyl acetate.

### Example 8

Example 8 was performed in the same manner as Example 7 to obtain a toner 8, except that the temperature of washing, heating treatment, and drying was changed from 50° C. for 15 minutes to 50° C. for 0 minute.

### Example 9

Example 9 was performed in the same manner as Example 8 to obtain a toner 9, except that 870 parts of water in the preparation of the water phase 1 in Example 8 was changed to 810 parts of water, 120 parts of 10% aqueous solution of sodium hydroxide was changed to 180 parts of 10% aqueous solution of sodium hydroxide.

### Example 10

Example 10 was performed in the same manner as Example 9 to obtain a toner 10, except that 1.0 part of the inorganic external additive A in the external additive mixture of Example 9 was changed to 1.0 part of the inorganic external additive B.

### Example 11

Example 11 was performed in the same manner as Example 9 to obtain a toner 11, except that 1.5 parts of hydrophobic silica in the external additive mixture of Example 9 was changed to 0.5 parts of hydrophobic silica and 1.0 parts of the inorganic external additive A in the external additive mixture of Example 9 was changed to 1.0 parts of the inorganic external additive C.

### Comparative Example 1

Comparative Example 1 was performed in the same manner as Example 1 to obtain a toner 12, except that 100 parts of the 50% ethyl acetate solution of the amorphous polyester prepolymer resin B-1 in the preparation of the oil phase 1 of Example 1 was changed to 100 parts of the 50% ethyl acetate solution of the amorphous polyester prepolymer resin B-2.

### Comparative Example 2

Comparative Example 2 was performed in the same manner as Example 1 to obtain a toner 13, except that the agitation 2 was not performed among the agitations 1 to 3 in the emulsification and solvent removal.

### Comparative Example 3

Comparative Example 3 was performed in the same manner as Comparative Example 2 to obtain a toner 14, except that the temperature of washing, heating treatment, and drying of Comparative Example 2 was changed from 50° C. for 15 minutes to 50° C. for 30 minutes.

### Comparative Example 4

Comparative Example 4 was performed in the same manner as Example 4 to obtain a toner 15, except that the heat treatment at 50° C. for 15 minutes as performed in Example 4 was not conducted in Comparative Example 4.

### Comparative Example 5

Comparative Example 5 was performed in the same manner as Example 1 to obtain a toner 16, except that 1.0 part of the inorganic external additive A of the external additive mixture of Example 1 was changed to 1.0 part of the inorganic external additive D.

### Comparative Example 6

Comparative Example 6 was performed in the same manner as Example 1 to obtain a toner 17, except that 1.5 parts of the hydrophobic silica of the external additive mixture of Example 1 was changed to 2.0 parts of the hydrophobic silica, and 1.0 part of the inorganic external additive A of the external additive mixture of Example 1 was changed to 1.0 part of the hydrophobic titanium oxide (ST-550, manufactured by Titan Kogyo Ltd.).

[Volume Average Particle Size Dv]

The Dv of the toner was measured using a Coulter counter (Coulter Multi Sizer II, manufactured by Beckman Coulter, Inc.). First, 0.1 mL to 5 mL of polyoxyethylene alkyl ether was added to 100 mL to 150 mL of aqueous electrolyte solution as a dispersant.

Here, the aqueous electrolyte solution is a 1, NaCl aqueous solution prepared using primary sodium chloride, and an ISOTON-II particle powder property measurement device (ISOTON-II, manufactured by Coulter, Inc.) was used. In addition, 2 mg to 20 mg of toner was added. The aqueous electrolyte solution in which the toner was suspended was dispersed for about 1 minute to 3 minutes using an ultrasonic disperser, and the particle size and number of particles of the toner were measured using a 100 μm aperture to determine Dv.

13 channels such as 2.00 μm or more and less than 2.52 μm; 2.52 μm or more and less than 3.17 μm; 3.17 μm or more and less than 4.00 μm; 4.00 μm or more and less than 5.04 μm; 5.04 μm or more and less than 6.35 μm; 6.35 μm or more and less than 8.00 μm; 8.00 μm or more and less than 10.08 μm; 10.08 μm or more and less than 12.70 μm; 12.70 μm or more and less than 16.00 μm; 16.00 μm or more and less than 20.20 μm; 20.20 μm or more and less than 25.40 μm; 25.40 μm or more and less than 32.00 μm; and 32.00 μm or more and less than 40.30 μm were used, and the particles with particle size of 2.00 μm or more and less than 40.30 μm were subjected to use.

[Average Circularity]

An average circularity of the toner was measured using a wet-flow particle size/shape analyzer and analysis software (FPIA (Registered Trademark) 2100 Data Processing Program for FPIA version 00-10, manufactured by Sysmex Corporation).

Specifically, 0.1 to 0.5 mL of a 10% aqueous solution of alkylbenzene sulfonate (NEOGEN (Registered Trademark) SC-A, manufactured by DSK Co., Ltd.) and 0.1 to 0.5 g of the toner were added to a 100 mL glass beaker, and then stirred using a microspatula, followed by adding 80 mL of ion-exchanged water.

Then, an ultrasonic disperser UH-50 (manufactured by STM) was used to disperse for 1 minute under the conditions of 20 kHz and 50 W/10 cm³, and then dispersed for a total of 5 minutes to obtain the measurement sample. Here, the average circularity of particles having a circle equivalent diameter of 0.60 μm or more and less than 159.21 μm was measured using a measurement sample with a particle concentration of 4000 to 8000/10⁻³ cm³.

[Bt−0.025×Ct]

Bt−0.025×Ct was calculated from Bt and Ct obtained by the following method.

[Bt]

Bt was measured using an automatic specific surface area/pore distribution measuring device TriStar3000 (TriStar 3000, manufactured by Shimadzu Corporation).

Specifically, approximately 1.0 g of the toner was weighed into a sample cell, and then vacuum dried using a pretreatment smart prep (manufactured by Shimadzu Corporation) for 24 hours to remove impurities and water content from the surface of the toner. Next, after the pretreated toner was set in the automatic specific surface area/pore distribution measuring device, the relationship between the nitrogen gas adsorption amount and the relative pressure was determined, and Bt was determined by the BET multi-point method.

[Ct]

The toner was observed by a field emission scanning electron microscope MERILIN (SII Nanotech, manufactured by MERILIN) to determine Ct.

Specifically, the following steps were performed. First, a secondary electron image of the toner was acquired. At this time, the substrate was used as a conductive tape, and the toner was acquired by selecting a contrast so as to have no portion in which the toner is brighter than the substrate and has no portion in which the image is completely collapsed in black and a portion in which the toner is solidly white. Next, the image obtained was loaded with GIMP for Windows (Registered Trademark), an image editing and processing software, and the portion judged as the external additive by visual inspection was filled with black (R:0, G:0, and B:0).

Next, an area ratio A was obtained for the entire image of the area filled with black through a binary process. Furthermore, a binarization process was performed at a moderate threshold of brightness for the original image read by GIMP for Windows (Registered Trademark) to obtain an area ratio B for the entire image of the toner projection image. Using a formula A/B, the ratio of the external additive region to the toner projection image was calculated, and the average value of 50 toners was set to Ct.

An example of SEM measurement conditions is indicated below.

[SEM Measurement Conditions]

Acceleration voltage: 3.0 kV

Working Distance (WD): 10.0 mm

(Preparation of Carriers) 100 parts of organostrate silicone, 5 parts of y-(2-aminoethyl)aminopropyltrimethoxysilane, and 10 parts of carbon black were added to 100 parts of toluene, and then dispersed using a homomixer for 20 minutes to obtain a protective layer coating solution.

A protective layer was formed by applying 1000 parts of spherical magnetite having an average particle size of 50 μm using a fluidized bed coating device to obtain a carrier.

(Preparation of Developing Agent)

5 parts of the toner 1 and 95 parts of the carrier were mixed using a ball mill to obtain a developing agent 1.

Developing agents 2 to 17 were obtained in the same manner as the developing agent 1, except that the toner 1 of the developing agent 1 was changed to the toners 2 to 17.

Image formation was performed using the prepared two-component developing agent, and the following evaluation was performed.

[Low Temperature Fixability]

A copying test was conducted on PPC paper (Type 6200, manufactured by Ricoh Co., Ltd.) using a device which was modified at the fixing part of a copying machine (Imagio (Registered Trademark) MF 2200, manufactured by Ricoh Co., Ltd.) using a Teflon (Registered Trademark) roller as a fixing roller.

Specifically, the cold offset temperature (lower limit of fixing temperature) was determined by changing the fixing temperature and was performed according to the following criteria. In the evaluation condition of the lower limit of the fixing temperature, the line speed of the paper feed was set to 120 mm/sec or more and 150 mm/sec or less, the surface pressure was set to 1.2 kgf/cm², and the nip width was set to 3 mm.

[Evaluation Criteria]

Excellent: Lower limit of fixing temperature is less than 110° C.

Good: Lower limit of fixing temperature is 110° C. or higher and less than 115° C.

Failure: Lower limit of fixing temperature is 115° C. or higher.

[Charging Stability]

Each developing agent was used to perform an endurance test in which a character image pattern with an image area ratio of 12% was used to output 100,000 sheets consecutively, and the change in the charge amount was evaluated. A small amount of the developing agent was sampled from the developing sleeve, and the change in the charge amount was determined by the blow-off method, and the change was evaluated according to the following criteria. The actual usable level is more than possible.

[Evaluation Criteria]

Excellent: The change in the charging amount is less than 3 μC/g.

Good: The change in the charging amount is 3 μC/g or more and less than 6 μC/g.

Fair: The change in the charging amount is 6 μC/g or more and less than 10 μC/g.

Failure: The change in the charge amount is 10 μC/g or more.

[Toner Scattering]

An image forming apparatus (IPSIO (Registered Trademark) Color 8100, manufactured by Ricoh Co., Ltd.) was modified to an oil-free fixing method and tuned. In an environment with a temperature of 40° C. and a humidity of 90% RH, an image area ratio of 5% was used for continuous output endurance test of 100,000 sheets. Then, toner contamination in the copying machine was visually observed, and the evaluation was performed according to the following criteria. The actual usable level is more than fair.

[Evaluation Criteria]

Excellent: Contamination in toner is not observed at all and is in good condition.

Good: Not a problem with only slight contamination in toner is observed.

Fair: Slight contamination in toner is observed.

Fail: Contamination is out of tolerable.

The conditions and evaluation results of Examples 1 to 11 and Comparative Examples 1 to 6 are indicated in Table 2.

TABLE 2

| | | | Examples | | | | | |
|---|---|---|---|---|---|---|---|---|
| | | | 1 | 2 | 3 | 4 | 5 | 6 |
| | Toner No | — | Toner 1 | Toner 2 | Toner 3 | Toner 4 | Toner 5 | Toner 6 |
| Amorphous | Type | — | B-1 | B-1 | B-1 | B-1 | B-1 | B-1 |
| polyester | Alcohol Component | — | 100% of 3-methyl-1,5-pentanediol | | | | | |
| resin B | carboxylic acid | — | 100% of adipic acid | | | | | |
| | component | | | | | | | |
| | Tg | ° C. | -55 | -55 | -55 | -55 | -55 | -55 |
| | Mw | — | 130000 | 130000 | 130000 | 130000 | 130000 | 130000 |
| Oil phase | Amorphous polyester | Parts | 320 | 320 | 320 | 320 | 320 | 320 |
| preparation | resin A | | | | | | | |
| | Ethyl acetate solution | | 100 | 100 | 100 | 100 | 100 | 100 |
| | of prepolymer B | | | | | | | |
| | Crystalline polyester | | 210 | 210 | 210 | 210 | 210 | 210 |
| | resin dispersion | | | | | | | |
| | Wax dispersion | | 220 | 220 | 220 | 220 | 220 | 220 |
| | Colorant master hatch | | 60 | 60 | 60 | 60 | 60 | 60 |
| | Ethyl acetate | | 180 | 100 | 180 | 180 | 100 | 50 |
| Water phase | Pure water | Parts | 990 | 990 | 870 | 810 | 990 | 990 |
| preparation | Vinyl based | | 83 | 83 | 83 | 83 | 83 | 83 |
| | resin dispersion | | | | | | | |
| | MON7 | | 37 | 37 | 37 | 37 | 37 | 37 |
| | Sodium sulfate solution | | 0 | 0 | 120 | 180 | 0 | 0 |
| | Ethyl acetate | | 90 | 90 | 90 | 90 | 90 | 90 |
| Emulsification | Agitation, first speed | rpm | 8000 | 8000 | 8000 | 8000 | 8000 | 8000 |
| | Agitation, 1 hour | min. | 2 | 2 | 2 | 2 | 2 | 2 |
| | Agitation, second speed | rpm | 2000 | — | 2000 | 2000 | 2000 | 2000 |
| | Agitation, 2 hours | min. | 1 | — | 1 | 1 | 1 | 1 |
| | Agitation, third speed | rpm | 500 | 500 | 500 | 500 | 500 | 500 |
| | Agitation, 3 hours | min. | 20 | 20 | 20 | 20 | 20 | 20 |
| Heat | Heating temperature | ° C. | 50 | 50 | 50 | 50 | 50 | 50 |
| treatment | Processing time | Hours | 15 | 15 | 15 | 0 | 15 | 15 |
| External | Toner base particles | Parts | 100 | 100 | 100 | 100 | 100 | 100 |
| additives | Silica UTP-35 | | 2 | 2 | 2 | 2 | 2 | 2 |
| | Silica NX-90G | | 1.5 | 1.5 | 1.5 | 1.5 | 1.5 | 1.5 |
| | Inorganic external | | | | | | | |
| | additive A | | | | | | | |
| | Inorganic external | | | | | | | |
| | additive B | | | | | | | |
| | Inorganic external | | | | | | | |
| | additive C | | | | | | | |
| | Inorganic external | | | | | | | |
| | additive D | | | | | | | |
| | Titunium oxide | | | | | | | |
| Physical | Volume average | μm | | | | | | |
| property | particle size Dv | | | | | | | |
| of toner | Circularity | — | 0.975 | 0.975 | 0.975 | 0.975 | 0.980 | 0.985 |
| | Bt-0.025 × Ct | — | 1.6 | 1.5 | 1.9 | 2.8 | 1.6 | 1.5 |
| Evaluation | Low temperature | — | Good | Good | Good | Good | Good | Good |
| | fixability | | | | | | | |
| | Charging stability | — | Fair | Fair | Fair | Good | Good | Good |
| | Toner scattering | — | Fair | Fair | Fair | Good | Good | Good |
| | | | | Examples | | | | |
| | | | | 7 | 8 | 9 | 10 | 11 |
| | Toner No | — | | Tones 7 | Toner 8 | Toner 9 | Toner 10 | Toner 11 |
| | Amorphous | Type | — | B-1 | B-1 | B-1 | B-1 | B-1 |
| | polyester | Alcohol Component | — | | | | | |
| | resin B | carboxylic acid | — | | | | | |
| | | component | | | | | | |
| | | Tg | ° C. | -55 | -55 | -55 | -55 | -55 |
| | | Mw | — | 130000 | 130000 | 130000 | 130000 | 130000 |
| | Oil phase | Amorphous polyester | Parts | 320 | 320 | 320 | 320 | 320 |
| | preparation | resin A | | | | | | |
| | | Ethyl acetate solution | | 100 | 100 | 100 | 100 | 100 |
| | | of prepolymer B | | | | | | |
| | | Crystalline polyester | | 210 | 210 | 210 | 210 | 210 |
| | | resin dispersion | | | | | | |
| | | Wax dispersion | | 220 | 220 | 220 | 220 | 220 |
| | | Colorant master hatch | | 60 | 60 | 60 | 60 | 60 |
| | | Ethyl acetate | | 50 | 50 | 50 | 50 | 50 |
| | Water phase | Pure water | Parts | 870 | 870 | 870 | 870 | 870 |
| | preparation | Vinyl based | | 83 | 83 | 83 | 83 | 83 |
| | | resin dispersion | | | | | | |
| | | MON7 | | 37 | 37 | 37 | 37 | 37 |
| | | Sodium sulfate solution | | 120 | 120 | 180 | 180 | 180 |
| | | Ethyl acetate | | 90 | 90 | 90 | 90 | 90 |
| | Emulsification | Agitation, first speed | rpm | 8000 | 8000 | 8000 | 8000 | 8000 |
| | | Agitation, 1 hour | min. | 2 | 2 | 2 | 2 | 2 |
| | | Agitation, second speed | rpm | 2000 | 2000 | 2000 | 2000 | 2000 |
| | | Agitation, 2 hours | min. | 1 | 1 | 1 | 1 | 1 |
| | | Agitation, third speed | rpm | 500 | 500 | 500 | 500 | 500 |
| | | Agitation, 3 hours | min. | 20 | 20 | 20 | 20 | 20 |
| | Heat | Heating temperature | ° C. | 50 | 50 | 50 | 50 | 50 |
| | treatment | Processing time | Hours | 15 | 0 | 0 | 0 | 0 |
| | External | Toner base particles | Parts | 100 | 100 | 100 | 100 | 100 |
| | additives | Silica UTP-35 | | 2 | 2 | 2 | 2 | 2 |
| | | Silica NX-90G | | 1.5 | 1.5 | 1.5 | 1.5 | 0.5 |
| | | Inorganic external | | | 1 | 1 | | |
| | | additive A | | | | | | |
| | | Inorganic external | | | | | 1 | |
| | | additive B | | | | | | |
| | | Inorganic external | | | | | | 1 |
| | | additive C | | | | | | |
| | | Inorganic external | | | | | | |
| | | additive D | | | | | | |
| | | Titunium oxide | | | | | | |
| | Physical | Volume average | μm | | | | | |
| | property | particle size Dv | | | | | | |
| | of toner | Circularity | — | 0.985 | 0.985 | 0.985 | 0.985 | 0.985 |
| | | Bt-0.025 × Ct | — | 1.9 | 2.1 | 2.9 | 2.9 | 2.9 |
| | Evaluation | Low temperature | — | Good | Good | Good | Good | Excellent |
| | | fixability | | | | | | |
| | | Charging stability | — | Good | Excellent | Excellent | Excellent | Excellent |
| | | Toner scattering | — | Good | Excellent | Excellent | Excellent | Excellent |
| | | | Comparative Examples | | | | | |
| | | | 1 | 2 | 3 | 4 | 5 | 6 |
| Toner No | — | | Toner 12 | Toner 13 | Toner 14 | Toner 15 | Toner 16 | Toner 17 |
| Amorphous | Type | — | B-2 | B-1 | B-1 | B-1 | B-1 | B-1 |
| polyester | Alcohol Component | — | 100% of 3-methyl-1,5-pentanediol | | | | | |
| resin B | carboxylic acid | — | 100% of | 100% of adipic acid | | | | |
| | component | | isophthalic | | | | | |
| | | | acid | | | | | |
| | Tg | ° C. | 5 | -55 | -55 | -55 | -55 | -55 |
| | Mw | — | 130000 | 130000 | 130000 | 130000 | 130000 | 130000 |
| Oil phase | Amorphous polyester | Parts | 320 | 320 | 320 | 320 | 320 | 320 |
| preparation | resin A | | | | | | | |
| | Ethyl acetate solution | | 100 | 100 | 100 | 100 | 100 | 100 |
| | of prepolymer B | | | | | | | |
| | Crystalline polyester | | 210 | 210 | 210 | 210 | 210 | 210 |
| | resin dispersion | | | | | | | |
| | Wax dispersion | | 220 | 220 | 220 | 220 | 220 | 220 |
| | Colorant master hatch | | 60 | 60 | 60 | 60 | 60 | 60 |
| | Ethyl acetate | | 180 | 180 | 180 | 180 | 180 | 180 |
| Water phase | Pure water | Parts | 990 | 990 | 990 | 810 | 990 | 990 |
| preparation | Vinyl based | | 83 | 83 | 83 | 83 | 83 | 83 |
| | resin dispersion | | | | | | | |
| | MON7 | | 37 | 37 | 37 | 37 | 37 | 37 |
| | Sodium sulfate solution | | 0 | 0 | 0 | 180 | 0 | 0 |
| | Ethyl acetate | | 90 | 90 | 90 | 90 | 90 | 90 |
| Emulsification | Agitation, first speed | rpm | 8000 | 8000 | 8000 | 8000 | 8000 | 8000 |
| | Agitation, 1 hour | min. | 2 | 2 | 2 | 2 | 2 | 2 |
| | Agitation, second speed | rpm | — | 2000 | 2000 | 2000 | 2000 | 2000 |
| | Agitation, 2 hours | min. | — | 1 | 1 | 1 | 1 | 1 |
| | Agitation, third speed | rpm | 500 | 500 | 500 | 500 | 500 | 500 |
| | Agitation, 3 hours | min. | 20 | 20 | 20 | 20 | 20 | 20 |
| Heat | Heating temperature | ° C. | 50 | 50 | 50 | — | 50 | 50 |
| treatment | Processing time | Hours | 15 | 15 | 30 | — | 15 | 15 |
| External | Toner base particles | Parts | 100 | 100 | 100 | 100 | 100 | 100 |
| additives | Silica UTP-35 | | 2 | 2 | 2 | 2 | 2 | 2 |
| | Silica NX-90G | | 1.5 | 1.5 | 1.5 | 1.5 | 1.5 | 1.5 |
| | Inorganic external | | 1 | 1 | 1 | 1 | | |
| | additive A | | | | | | | |
| | Inorganic external | | | | | | | |
| | additive B | | | | | | | |
| | Inorganic external | | | | | | | |
| | additive C | | | | | | | |
| | Inorganic external | | | | | | | |
| | additive D | | | | | | | |
| | Titunium oxide | | | | | | | |
| Physical | Volume average | μm | | | | | | |
| property | particle size Dv | | | | | | | |
| of toner | Circularity | — | 0.975 | 0.975 | 0.975 | 0.975 | 0.975 | 0.975 |
| | Bt-0.025 × Ct | — | 1.6 | 1.5 | 1.4 | 3.1 | 1.5 | 1.6 |
| Evaluation | Low temperature | — | Failure | Good | Good | Good | Good | Failure |
| | fixability | | | | | | | |
| | Charging stability | — | Good | Failure | Failure | Failure | Failure | Good |
| | Toner scattering | — | Good | Failure | Failure | Failure | Failure | Good |

From Table 2, in Examples 1 to 11, the low temperature fixability, the charge stability, and the toner scattering were all good. Of these, in Examples 4 to 11, the charging stability and the toner scattering were improved. Among them, in Examples 8 to 11, the charging stability and the toner scattering were further improved. Of these, in Example 11, the low temperature fixability was improved.

In contrast, the low temperature fixabilities in Comparative Examples 1 and 6 indicated failure. In Comparative Examples 2 to 5, charging stabilities and toner dispersions indicated failure.

While embodiments of the invention have been described, the invention is not limited to specific embodiments, and various modifications and variations are possible within the scope of the invention as claimed.

What is claimed is:

1. A toner, comprising:
base particles; and
an external additive,
wherein a glass transition temperature obtained from a differential scanning calorimetry curve at a second warming of a tetrahydrofuran-insoluble component is −50° C. or higher and 10° C. or lower,
wherein an average circularity of the toner is 0.975 or more and 0.985 or lower,
wherein the toner satisfies the following formula:
1.5≤Bt−0.025×Ct≤53.0,
wherein the Bt [m²/g] is a BET specific surface area of the toner particles, and the Ct [%] is a coverage by the external additive, and,
wherein at least a portion of a surface of the external additive is coated with either an oxide of a metallic element, a hydroxide of the metallic element, or both, and further coated with an organic compound.

2. The toner according to claim 1,
wherein the average circularity of the toner is 0.980 or more and 0.985 or less.

3. The toner according to claim 1,
wherein the toner further satisfies the following formula:
2.0≤Bt−0.025×Ct≤3.0.

4. The toner according to claim 1,
wherein the external additive is silica.

5. The toner according to claim 1,
wherein the metallic element is at least one selected from aluminum, zinc, magnesium, and barium.

6. The toner according to claim 1,
wherein an average primary particle size of the external additive is 15 nm or more and 50 nm or less.

7. The toner according to claim 1,
wherein the external additive is coated with an alkylsilane having 4 or less carbon atoms.

8. A developing agent containing the toner of claim 1.

9. A toner housing unit containing the toner of claim 1.

10. An image forming apparatus, comprising:
a photoreceptor;
a charger to charge the photoreceptor;
an exposing unit that forms an electrostatic latent image by exposing the charged photoreceptor;
a developer that develops the electrostatic latent image formed on the photoreceptor using the toner of claim 1 to form a toner image;
a transferring unit that transfers the toner image formed on the photoreceptor to a recording medium; and
a fixing unit to fix the toner image transferred to the recording medium.

11. A method of forming images, comprising:
charging a photoreceptor;
exposing the charged photoreceptor to form an electrostatic latent image;
developing the electrostatic latent image formed on the photoreceptor using the toner of claim 1 to form a toner image;
transferring the toner image formed on the photoreceptor to a recording medium; and
fixing the toner image transferred to the recording medium.
